(19) United States
(12) Patent Application Publication
(10) Pub. No.: US 2026/0290310 A1
(43) Pub. Date: Sep. 24, 2026

(54) SYSTEM

(71) Applicant: SoftBank Group Corp., Tokyo (JP)

(72) Inventor: Kazuya TAKAKI, Tokyo (JP)

(73) Assignee: SoftBank Group Corp., Tokyo (JP)

(21) Appl. No.: 19/567,388

(22) Filed: Mar. 16, 2026

(30) Foreign Application Priority Data
Mar. 19, 2025 (JP) 2025-045120

(51) Int. Cl. G10L 13/033; G06F 3/16; G06F 40/117; G06F 40/166; G06F 40/58; G10L 13/027

(52) U.S. Cl. CPC G10L 13/033; G06F 40/117; G06F 40/166; G06F 40/58; G10L 13/027; G06F 3/165

(57) ABSTRACT

A system includes a processor that is configured to receive information including at least a user age, a user gender, and user preferences, generate a prompt sentence based on the received information and generate a story by using a generative artificial intelligence model in accordance with the prompt sentence, and convert the generated story into audio data and provide a read-aloud output of the generated story to the user.

### CROSS-REFERENCE TO RELATED APPLICATION

This application is based on and claims priority under 35 USC 119 from Japanese Patent Application No. 2025-045120 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional bedtime story systems and content delivery services generally rely on pre-authored, fixed stories that are selected manually by a user. Such systems are not sufficiently capable of tailoring story content to an individual user's attributes such as age, gender, and personal preferences, and therefore often fail to maintain the user's interest or provide an optimal educational or emotional experience. Furthermore, conventional systems typically do not adapt the story in real time in response to a user's emotional state, and thus cannot dynamically adjust the story content or progression to calm, comfort, or appropriately engage the user. In addition, known systems provide limited support for multilingual delivery and flexible digital distribution, which restricts access for users in different linguistic environments and complicates the sharing or reuse of generated content across platforms. Accordingly, there is a need for a system that can automatically generate personalized stories using generative artificial intelligence based on user information, convert those stories into audio for read-aloud output, adapt the story in accordance with the user's emotional state, and further translate and distribute the stories in digital formats suitable for multilingual and cross-platform use.

### SUMMARY

In order to solve the above-described problems, a system according to one aspect of the present invention comprises a processor, wherein the processor is configured to receive information including at least a user age, a user gender, and user preferences, generate a prompt sentence based on the received information, generate a story by using a generative artificial intelligence model in accordance with the prompt sentence, convert the generated story into audio data, and provide a read-aloud output of the generated story to the user. In this manner, the system automatically creates and narrates personalized story content that is tailored to the individual user. In addition, in some embodiments, the processor is configured to analyze an emotional state of the user and adjust at least one of content and progression of the story based on a result of the analysis, thereby enabling dynamic adaptation of the story to calm or engage the user in response to emotional changes. Furthermore, in some embodiments, the processor is configured to translate the generated story into a plurality of languages, convert the translated story into a digital format, and distribute the translated story in the digital format, thereby facilitating multilingual accessibility and flexible distribution or sharing of the personalized stories across various devices and services.

The term “processor” refers to a hardware and/or software component, such as a central processing unit, microcontroller, dedicated logic circuitry, or a combination thereof, that executes instructions to perform the functions described in the claims, including receiving information, generating prompts, generating stories, converting stories into audio data, analyzing emotional states, translating stories, and distributing digital content.

The term “user” refers to a human individual, including but not limited to a child, a parent, or a guardian, who interacts directly or indirectly with the system and for whom the story is generated, narrated, or otherwise provided.

The term “user age” refers to information indicating the chronological age of the user, expressed, for example, in years, and used by the processor to tailor story complexity, vocabulary, and themes to an appropriate developmental level.

The term “user gender” refers to information indicating a gender attribute of the user, such as male, female, or another gender identification, and used by the processor to personalize story characters, pronouns, and narrative style as desired.

The term “user preferences” refers to information representing likes, interests, tastes, or favored themes of the user, such as preferred topics, genres, or characters, which the processor uses to influence the subject matter and style of the generated story.

The term “prompt sentence” refers to a text string or structured textual instruction generated by the processor based on received user information, and provided as an input to a generative artificial intelligence model to control or guide the story generation process.

The term “generative artificial intelligence model” refers to a machine learning model, such as a neural network-based language model, trained on textual data and configured to automatically generate story text in response to a given prompt sentence.

The term “story” refers to a sequence of textual content including narrative sentences, dialogues, and descriptions, generated by the generative artificial intelligence model and intended to form a coherent narrative suitable for presentation to the user.

The term “audio data” refers to digital data representing sound, including encoded or unencoded waveform information, which is generated by converting the story text into speech or another auditory form for playback to the user.

The term “read-aloud output” refers to an audible presentation of the generated story, produced by playing back the audio data through a speaker or other audio output device so that the user can listen to the story.

The term “emotional state of the user” refers to an inferred or detected psychological condition of the user, such as calmness, excitement, fear, boredom, or happiness, obtained for example from biometric signals, facial expressions, voice analysis, or user input, and used by the processor to adjust the story.

The term “content of the story” refers to narrative elements of the story, including plot, events, characters, dialogues, descriptive passages, and thematic emphasis, which can be modified or selected by the processor.

The term “progression of the story” refers to the temporal and structural development of the story, including pacing, ordering of scenes, length, timing of climactic events, and introduction or resolution of narrative elements, which the processor can adjust during presentation.

The term “translate” refers to the operation of converting the text of the generated story from a source language into one or more target languages while preserving, as far as practicable, the meaning, tone, and structure of the original story.

The term “plurality of languages” refers to two or more different natural languages, such as English, Japanese, Chinese, Spanish, or other human languages, into which the story can be translated by the processor.

The term “digital format” refers to an electronic data format suitable for storage, processing, and transmission by computing devices, including but not limited to text files, audio files, e-book files, or container formats such as PDF or EPUB, in which the translated story can be represented.

The term “distribute” refers to the operation of making the digital-format story available to one or more recipients or devices, including transmitting, streaming, downloading, or otherwise providing the story through a network, storage medium, or service platform.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

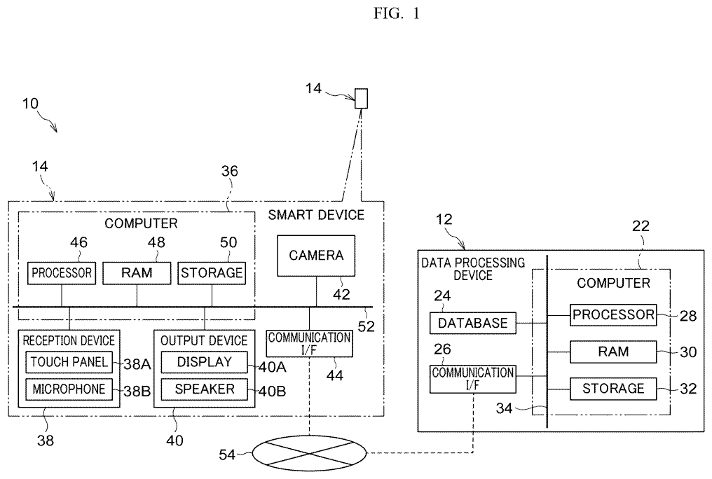

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

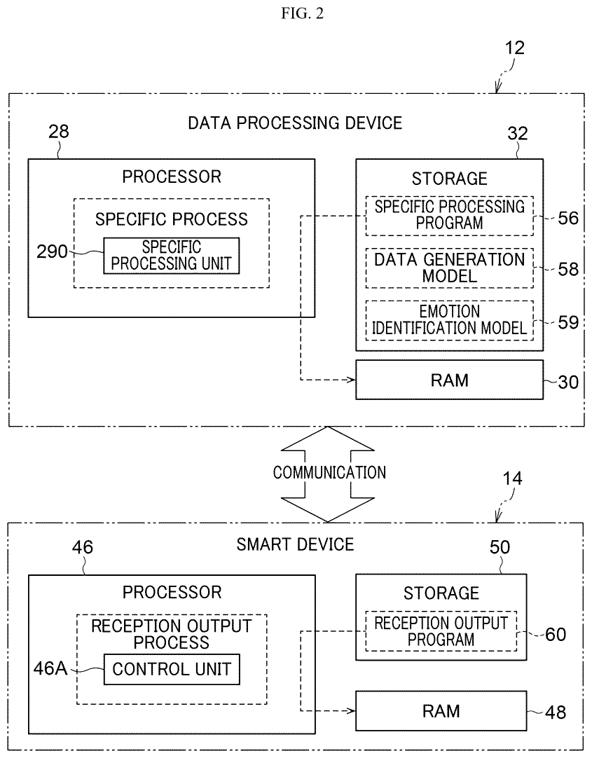

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented bedtime story systems generally rely on static content repositories or simple parameterized templates. Such systems often select a story from a fixed database based on coarse user attributes, such as age group or a broad genre tag. As a result, these systems are unable to dynamically adapt narrative content at a fine-grained level to the specific attributes and context of an individual child. In particular, conventional systems do not effectively leverage generative AI models through well-structured prompt sentences, and therefore cannot provide highly personalized, context-aware stories that match detailed child attributes, such as nuanced preferences, desired tone, or target story length. Furthermore, existing systems that do employ generative AI models typically expose the models in a generic way and delegate all control logic to the model, without establishing a robust, repeatable prompt construction pipeline on the client side and without constrained, layered post-processing on the server side. Such configurations can lead to inconsistent output quality, excessive or insufficient story length, and content that is not reliably child-appropriate. In addition, these systems do not maintain a structured history of attributes and prompt sentences, and therefore cannot efficiently regenerate variant stories while preserving previously effective parameters.

Additionally, conventional systems often treat speech synthesis as a simple text-to-speech conversion without coordinated control of prosodic parameters, such as speaking rate, voice characteristics, intonation, and insertion of pauses, specifically tuned for bedtime and relaxation. Consequently, the resulting audio output may be difficult for a child to follow, may not promote a calming atmosphere, and may not reliably assist with sleep.

Moreover, multilingual and distribution aspects are frequently handled as afterthoughts. Existing systems either lack a systematic mechanism for translating and synthesizing stories into multiple languages with consistent quality, or they do not provide integrated cataloging and distribution management for generated story content. This limits the ability to reuse, curate, or commercially provide high-quality, customized story content across different languages and usage contexts.

Therefore, there is a need for an improved computer-implemented system that (i) acquires detailed child-related attribute information, (ii) constructs structured prompt sentences for a generative AI model in a controlled and repeatable manner, (iii) performs server-side constrained generation and post-processing of story text, (iv) executes speech synthesis with fine-grained control parameters suited for bedtime storytelling, and (v) manages multilingual generation, storage, and distribution of the resulting story content. Such a system should enhance the functioning of the overall computer-based storytelling pipeline by improving determinism, safety, adaptability, and reusability of AI-generated bedtime stories.

The specific processing by the specific processing unit 290 of the data processing device 12 in Example 1 is realized by the following means.

The present invention provides a server comprising a processing circuitry configured to receive, via a communication network from a client terminal, request information including a prompt sentence dynamically constructed based on attribute information regarding a listener, the attribute information including at least age, gender, and preference information; to prepare, based on the received prompt sentence, model input information including the prompt sentence and generation control parameters; to invoke a generative AI model using the model input information so as to automatically generate story text; to perform post-processing on the generated story text according to at least one constraint including a child-appropriateness constraint and a length constraint, the post-processing including at least formatting, filtering, and insertion of markup for speech synthesis; to execute speech synthesis processing on the post-processed story text while setting speech control information including at least speaking rate, voice characteristics, intonation, and pauses, thereby generating audio data; to optionally perform machine translation on the story text into at least one additional language and execute the speech synthesis processing for each language so as to generate a plurality of audio data variants; to store the story text and the audio data as content information together with catalog information and identification information; and to provide, in response to distribution requests from a plurality of client terminals, selected content information including the audio data and associated metadata based on the catalog information. This enables an improved computer-implemented storytelling pipeline in which the server cooperates with a client terminal to control the generative AI model via structured prompt sentences, to constrain and normalize the model output for child-appropriate bedtime use, to generate prosodically optimized audio stories, and to support multilingual generation, storage, and distribution of personalized bedtime story content in a consistent and reusable manner.

The term “attribute information” refers to information relating to a listener or user, including at least age, gender, and preference information such as favored themes, genres, or tones of stories.

The term “structured information” refers to data in which attribute information and related parameters are organized in a machine-readable format, such as a record, object, or key-value set, suitable for programmatic processing.

The term “prompt sentence” refers to a natural language instruction or query constructed based on structured information, which is provided as input to a generative AI model in order to control generation of story text.

The term “generative AI model” refers to a machine learning model, such as a neural network-based language model, configured to generate textual content in response to an input prompt sentence.

The term “generation condition” refers to one or more parameters used to control behavior of the generative AI model, including at least constraints relating to output length, style, tone, or safety level.

The term “request information” refers to data transmitted from a client terminal to a server-side processing apparatus, including at least a prompt sentence and one or more generation conditions for use by a generative AI model.

The term “server-side processing apparatus” refers to a computing apparatus, such as a server device or a group of server devices, configured to perform processing including story text generation, post-processing, translation, speech synthesis, and content management.

The term “story text” refers to textual data representing a narrative, including at least sentences and paragraphs that form a coherent story suitable for presentation to a listener.

The term “post-processing” refers to processing performed on story text after generation by a generative AI model, including at least formatting, filtering, enforcing constraints, and inserting markup for subsequent speech synthesis.

The term “child-suitability constraint” refers to a constraint defining content criteria to ensure that story text is appropriate for children, including at least exclusion of violent, frightening, or otherwise unsuitable expressions.

The term “length constraint” refers to a constraint defining an allowable range or target for the size of story text, such as a number of characters, tokens, sentences, or an approximate playback duration.

The term “control information” refers to information specifying parameters for speech synthesis, including at least speaking rate, voice quality, intonation, and insertion of pauses.

The term “speaking rate” refers to a parameter indicating speed at which synthesized speech is output, such as words per minute or relative speed level.

The term “voice quality” refers to characteristics of synthesized speech, including at least timbre, pitch range, and perceived age or gender of the synthetic voice.

The term “intonation” refers to a prosodic pattern applied to synthesized speech, including variation in pitch, stress, and rhythm across phrases and sentences.

The term “pause” refers to a period of silence or reduced sound inserted between portions of synthesized speech, used to separate phrases, sentences, or paragraphs and to improve listenability.

The term “audio data” refers to digital data representing sound, including at least encoded samples of synthesized speech in a predetermined audio format.

The term “communication network” refers to a data communication infrastructure by which a client terminal and a server-side processing apparatus exchange information, and includes at least wired or wireless networks using standard communication protocols.

The term “client terminal” refers to an information processing apparatus, such as a portable terminal, smartphone, tablet, or other user-operated device, configured to acquire attribute information, generate a prompt sentence, transmit request information, and reproduce audio data.

The term “storage” refers to a computer-readable recording medium or memory device configured to store data such as attribute information, history information, story text, audio data, and catalog information.

The term “reproduction control information” refers to information used to control playback of audio data, including at least identifiers, playback position, and user-selectable operations such as play, pause, stop, and volume settings.

The term “history information” refers to stored information relating to past interactions, including at least attribute information, prompt sentences, and associated story generation results.

The term “additional input” refers to user-provided information that modifies or supplements existing attribute information or prompt sentences, such as a request for variation in content or characters.

The term “machine translation” refers to an automated process in which story text in a first language is converted into story text in at least one different language using a computational translation technique.

The term “identification information” refers to data that uniquely or distinctively identifies content information or audio data variants, such as identifiers, labels, or indices.

The term “distribution format” refers to a format or arrangement in which content information, including story text and audio data, is stored and managed for provision to one or more client terminals.

The term “content information” refers to information representing at least story text and corresponding audio data, optionally combined with metadata regarding attributes, language, and usage conditions.

The term “catalog information” refers to information that organizes and describes content information for presentation and selection, including at least titles, identifiers, language indicators, categories, and availability status.

The term “distribution management processing” refers to processing for controlling provision of content information to client terminals, including at least access control, pricing control, logging, and responding to content requests.

The term “metadata” refers to auxiliary information associated with content information or audio data, including at least descriptive, technical, and administrative attributes.

The term “listener” refers to an intended recipient of a story, typically a child in the context of bedtime storytelling, who listens to audio data generated by the system.

The term “play operation” refers to a user action or instruction that causes audio data to begin or resume playback.

The term “pause operation” refers to a user action or instruction that temporarily suspends playback of audio data while retaining a current playback position.

The term “stop operation” refers to a user action or instruction that terminates playback of audio data and may reset the playback position.

The term “volume adjustment” refers to operations or settings that change the loudness of reproduced audio data output from an output apparatus.

The term “output apparatus” refers to a device or component that converts audio data into sound, including at least speakers and headphones.

In an embodiment, a server cooperates with a terminal operated by a user to implement a personalized bedtime story delivery system using a generative AI model. The server and the terminal are realized by one or more general-purpose computers including at least a processor, a memory, a storage device, a network interface, and an audio interface.

The terminal is, for example, a portable information processing device such as a smartphone or tablet running an operating system, while the server is, for example, a rack-mounted computing apparatus running a server-oriented operating system. The server and the terminal communicate via a communication network using standardized communication protocols.

The terminal executes an application program that presents a graphical user interface to the user. The terminal uses a display unit and touch input or physical buttons to allow the user to enter attribute information related to a child listener. The user operates the terminal to input the child's age, gender, favorite themes, preferred language, and preferred story duration. The terminal converts the input events into digital data using an input driver and stores them in a main memory as attribute information represented in a structured internal format.

The terminal uses an application framework to construct structured information containing the attribute information. The terminal maps each user input field to a key in an internal record, for example, assigning age to an integer field, gender to an enumerated field, themes to an array of strings, and language and length to respective encoded fields. The terminal maintains the structured information in a memory-resident data structure, such as a key-value object, to facilitate subsequent data processing.

The terminal generates a prompt sentence based on the structured information. The terminal applies a deterministic template mapping algorithm that transforms the structured information into a natural language instruction. The terminal retrieves a template corresponding to a bedtime-story use case and fills template placeholders with the attribute information using string concatenation and formatting operations. For example, when the user specifies that the child is a 5-year-old girl who likes animals and gentle stories, the terminal constructs a prompt sentence such as:

“Please create a bedtime story for a 5-year-old girl who likes animals and gentle stories. The story should be calm and about 5 minutes long, and should help the child fall asleep.”

In another example, when the user specifies a 4-year-old boy who likes dinosaurs, the terminal constructs a prompt sentence such as:

“Please create a soothing bedtime story for a 4-year-old boy who likes dinosaurs. The story should be simple and last about 5 minutes.”

In yet another example, when the user specifies a 6-year-old girl who loves space and stars and requests Japanese language, the terminal constructs a prompt sentence such as:

“Generate a calm bedtime story in Japanese for a 6-year-old girl who loves space and stars. Use easy words that a child can understand.”

The terminal can further generate a variant prompt sentence when the user requests another story using similar settings but with different characters, for example:

“This time, please create a different bedtime story with new animal characters, but keep the same age, gender, and calm tone.”

The terminal reduces computational load on the server by performing this prompt construction at the client side, so that the server receives well-structured, normalized textual instructions rather than raw, noisy user input. This arrangement improves overall computational efficiency because the server can directly use the prompt sentence without extensive server-side parsing and normalization.

The terminal transmits the prompt sentence and associated generation conditions to the server over the communication network. The terminal encapsulates the prompt sentence and parameters such as target language, maximum token count, and safety level into a request message and sends the message through the network interface. The terminal uses a connection-oriented transport protocol and a secure application protocol so that the request is reliably and securely delivered. By encoding the request in a standardized format and compressing it when appropriate, the terminal reduces communication overhead and contributes to lowering network latency.

The server receives the request, extracts the prompt sentence and generation conditions, and prepares input data for a generative AI model. The server performs syntactic checks and length checks on the prompt sentence and discards illegal control characters, thereby preventing malformed input from degrading model performance or causing failures. The server then constructs model input tokens using a tokenizer associated with the generative AI model, converting the sequence of characters of the prompt sentence into a sequence of integer token identifiers stored in a tensor-like data structure. This conversion enables the generative AI model to process the prompt sentence efficiently on the server's processor or an attached accelerator.

In an embodiment, the server employs a generative AI model implemented as a transformer-based neural network. The generative AI model comprises a plurality of attention blocks, each block including a multi-head self-attention mechanism, layer normalization, and feed-forward sublayers. The server stores model parameters, including token embeddings, positional encodings, attention weights, and feed-forward weights, in a memory device. The server loads the model parameters into a high-speed memory associated with the processor or accelerators and uses linear algebra operations to compute attention scores and hidden representations for each token.

The server uses a training history of the generative AI model where the model has been pre-trained on a large corpus of text and optionally fine-tuned on child-appropriate stories. During training, the model has minimized a loss function, for example, a cross-entropy error between predicted tokens and actual tokens, using gradient-based optimization such as stochastic gradient descent with adaptive learning rate adjustments. The server has previously updated model weights during training by computing gradients using backpropagation and adjusting weights to reduce the loss. The server can also apply data augmentation techniques during training, such as paraphrasing or noise injection, to improve the robustness of the model for various prompt sentences.

At inference time, the server prevents the generative AI model from producing inappropriate content by constraining the decoding process. The server uses sampling algorithms, such as top-k or nucleus sampling, constrained by a safety filter that prohibits tokens mapped to disallowed categories (for example references to violence or fear). The server applies these constraints during token selection, rather than only as a post-hoc filter, thereby reducing the need for discarding entire generated sequences and improving computational efficiency. The server generates story text by repeatedly invoking the generative AI model over the tokenized prompt. The server maintains an internal buffer of tokens, appends newly generated tokens step by step, and stops generation when a specified maximum length is reached or when an end-of-sequence token is produced. The server transforms the final token sequence back into characters using a detokenizer and obtains story text as a string in memory. The server then performs post-processing, including segmentation into paragraphs, normalization of punctuation, and insertion of markup for pauses, for example tags that indicate breaks between sentences.

The server applies a child-suitability constraint by scanning the generated story text against a stored list of prohibited term patterns and semantic categories. The server uses a combination of lexical matching and an auxiliary classifier network that has been trained to assign a safety score to text segments. The classifier network may be a smaller neural model that takes sentence embeddings as input and outputs a probability measure of appropriateness. When the server detects suspicious segments, the server can regenerate those parts with adjusted generation conditions, for example lower temperature or a modified prompt sentence including an explicit prohibition. This targeted regeneration reduces overall processing time compared to regenerating an entire story from scratch and improves content reliability.

The server applies a length constraint by estimating reading time based on token count and average speaking rate. The server truncates or extends the story text to fall within the requested duration, inserting summarizing or concluding sentences when necessary. Because the server estimates reading time using token statistics and known speech synthesis parameters, the system can provide more accurate control of actual playback duration than human estimation or naive character counting.

The server performs speech synthesis on the post-processed story text. In one embodiment, the server uses a text-to-speech module that accepts text and a set of control parameters including speaking rate, pitch, timbre, and pause positions. The server first converts the story text and markup into a phoneme sequence using a linguistic front-end module, and then maps the phoneme sequence to acoustic features using an acoustic model, which may also be implemented as a neural network such as a sequence-to-sequence model. The server then converts the acoustic features into an audio waveform using a vocoder module, which may be a neural vocoder or a traditional signal processing-based vocoder. By tightly coupling markup insertion and speech synthesis parameters, the server generates audio that is optimized for bedtime listening, with slower speaking, smoother intonation, and deliberate pauses to promote relaxation.

The server may also perform machine translation on the story text into one or more additional languages. The server uses a translation module, which may be a neural sequence-to-sequence model trained for multilingual translation. The server converts the source story text into intermediate representations and decodes those representations into target-language text. For each target language, the server performs speech synthesis using language-appropriate voices and prosodic settings. By centralizing translation and synthesis on the server, the system achieves consistent quality control and avoids redundant resource consumption on multiple terminals.

The server stores the story text and audio data together with metadata and catalog information. The server assigns identifiers, language codes, intended age ranges, and tags describing themes and length. The server keeps this content information in a structured database or object storage. The server also maintains indexes to support efficient retrieval by attribute and by history. This storage structure allows the server to respond quickly to terminal requests for previously generated or purchased stories without invoking the generative AI model again, thereby improving response time and reducing computational load.

The terminal receives the audio data and associated metadata from the server. The terminal writes the audio data to a local storage area and registers metadata entries in a local catalog. The terminal then uses an audio playback module to decode the audio and send it to an output apparatus such as a built-in speaker or connected earphones. The terminal provides playback controls to the user, including play, pause, stop, and volume adjustment. The terminal updates playback state and current time position in memory so that the user can resume from a particular position if desired.

The terminal also stores as history information the attribute information and the prompt sentences used in previous requests. The terminal uses this history information to automatically generate new prompt sentences when the user requests variation. The terminal can, for example, retrieve a stored attribute set, add a phrase indicating “different characters” or “shorter story,” and reconstruct an updated prompt sentence. By embedding such logic at the terminal, the system reduces the amount of state that must be kept on the server and therefore lowers server memory usage and simplifies server-side synchronization.

The server and the terminal together improve computer technology beyond mere automation of human storytelling. The structured prompt pipeline implemented at the terminal reduces ambiguity and normalizes inputs prior to model inference, leading to reduced error rates and fewer failed generations. The constrained decoding and safety-aware generation at the server reduce unnecessary regenerations and allow partial regeneration of only problematic segments, thereby lowering computation time and energy consumption on expensive neural network operations. The tight integration of length estimation with speech synthesis parameters results in more accurate control of playback duration and improved user experience. The multilingual translation and synthesis pipeline allows a single generated narrative to be efficiently reused across languages by applying systematic translation and speech generation, instead of requiring manual rewriting or independent generation per language.

Moreover, the described architecture changes the way generative AI is used within a networked system. Instead of treating the generative AI model as a black-box text generator, the server uses explicit, machine-structured prompt sentences, safety filters, and prosody control as technical mechanisms that shape the model's behavior. The server leverages internal data structures such as token sequences, phoneme sequences, and acoustic features to coordinate network I/O, CPU computations, and storage in a non-conventional sequence that yields improved determinism and repeatability. The server and the terminal together thereby enhance data management, reduce communication overhead, and improve computational efficiency across the whole pipeline.

In another embodiment, the server can be configured to host multiple variants of generative AI models differing in parameter size or training specialization. The server selects an appropriate model variant based on requested length, language, and server load. For short, simple stories, the server may choose a smaller model to reduce computation time, whereas for longer or more complex narratives, the server may select a larger model. This dynamic model selection is performed by comparing computational cost estimates and target latency thresholds stored in a configuration table. Thus, the system adapts computational resources in real time to meet quality and performance goals, providing a technical solution to balancing latency and quality in networked AI services.

In another embodiment, the terminal can perform partial local speech synthesis for small segments, such as introductory or concluding phrases, while leaving the main story synthesis to the server. This hybrid arrangement distributes workload and reduces the size of audio data transferred from the server. For example, the terminal can locally generate a phrase such as “Now we will listen to your special bedtime story,” using a locally stored synthesizer, while the server provides only the main narrative audio. This reduces bandwidth consumption and can improve responsiveness at the start of playback.

In yet another embodiment, the server can log anonymized statistics on prompt patterns, generation lengths, regeneration frequency, and safety filter triggers. The server uses these statistics to adjust model parameters or decoding strategies in subsequent deployments, for example lowering temperature when safety filters activate too often. This feedback loop improves the precision and stability of the generation process over time, thereby directly enhancing the computational behavior of the AI subsystem rather than merely mirroring human adjustments.

Through these embodiments, the system provides concrete technical means by which the server and the terminal cooperate to transform user inputs into structured prompt sentences, generate and refine story text using a generative AI model with specific internal architectures, convert the story text into prosodically controlled audio, and manage multilingual storage and distribution of resulting content. The described configuration, data structures, and control flows yield measurable improvements in processing speed, content appropriateness, playback quality, and resource utilization, thereby enabling others skilled in the art to implement and apply the invention in diverse computing environments.

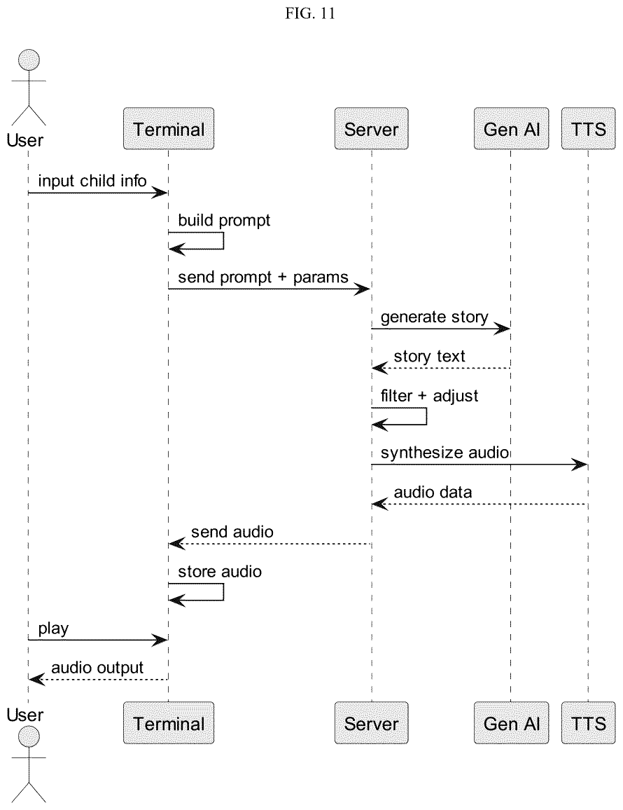

The following describes the processing flow using FIG. 11.

### Step 1

The user operates the terminal to start a storytelling application and to input attribute information.

The terminal displays input fields for age, gender, favorite themes, preferred language, and desired story length.

Input: touch or keyboard events representing the user's entries.

The terminal converts these events into digital values, validates ranges (for example, age>0), and maps each field into an internal record (for example, age as an integer, gender as an enumeration, themes as a list of strings).

Output: a structured attribute record stored in the terminal's memory.

### Step 2

The terminal generates structured information based on the attribute record.

Input: the attribute record created in Step 1.

The terminal builds a key-value data structure, assigning keys such as “age”, “gender”, “themes”, “language”, and “length” to the corresponding values, and normalizes formats (for example, lowercasing theme strings, converting length into a standard category like “short” or “long”).

Output: normalized structured information ready for prompt generation.

### Step 3

The terminal constructs a prompt sentence for a generative AI model using the structured information.

Input: the normalized structured information from Step 2.

The terminal selects a template for bedtime stories and performs string substitutions to fill placeholders. For example, for a 5-year-old girl who likes animals and gentle stories, the terminal constructs:

“Please create a bedtime story for a 5-year-old girl who likes animals and gentle stories. The story should be calm and about 5 minutes long, and should help the child fall asleep.” The terminal may also append additional constraints, for example, “Avoid any scary elements.”

Output: a complete prompt sentence stored as a text string.

### Step 4

The terminal prepares request information including the prompt sentence and generation conditions.

Input: the prompt sentence from Step 3 and local configuration data (for example, maximum tokens, target language, safety level).

The terminal combines these into a request structure, assigning fields such as “prompt”, “max_tokens”, “language”, and “safety_level”. The terminal may compress or serialize this structure for network transfer.

Output: a request message containing the prompt sentence and generation parameters.

### Step 5

The terminal transmits the request message to the server via a communication network.

Input: the request message produced in Step 4.

The terminal opens a network connection, sets protocol headers, and sends the message to a designated server endpoint. The terminal then waits for a response or error code.

Output: a network packet stream delivered to the server and a pending state at the terminal awaiting server output.

### Step 6

The server receives the request and parses the prompt sentence and parameters.

Input: the network packets sent in Step 5.

The server reconstructs the request message, decodes it, and reads fields such as “prompt” and “max_tokens”. The server strips invalid characters and checks that the prompt length is within defined limits.

Output: a sanitized prompt sentence and associated generation conditions stored in server memory.

### Step 7

The server tokenizes the prompt sentence and prepares input tensors for the generative AI model.

Input: the sanitized prompt sentence from Step 6.

The server applies a tokenizer to split the text into tokens (for example, words or subword units), and maps each token to an integer identifier using a vocabulary table. The server arranges these identifiers into an ordered sequence and embeds them into a numerical vector representation suitable for the neural network.

Output: a token sequence and corresponding input tensor for the generative AI model.

### Step 8

The server invokes the generative AI model to generate story text based on the prompt sentence.

Input: the token sequence and model parameters from Step 7 and stored model weights.

The server feeds the tokens through a transformer-based network, performing matrix multiplications, attention score calculations, and non-linear activations at each layer. The server iteratively computes probability distributions over next tokens and selects tokens using a decoding strategy (for example, top-k or nucleus sampling) under configured temperature and safety-related constraints.

Output: a generated token sequence representing the story, stored as a sequence of token identifiers.

### Step 9

The server converts the generated token sequence back into text and performs post-processing.

Input: the generated token sequence from Step 8.

The server uses a detokenizer to map token identifiers back to character sequences, obtaining a raw story string. The server then normalizes whitespace and punctuation, segments text into paragraphs, and may insert markup such as pause indicators between sentences.

Output: a formatted story text string with optional markup.

### Step 10

The server applies child-suitability and length constraints to the story text. Input: the formatted story text from Step 9 and constraint settings derived from the generation conditions.

The server checks the text against a list of prohibited words and uses a classifier model to score sentences for appropriateness. When disallowed patterns are detected, the server modifies or regenerates corresponding segments by re-invoking the generative AI model with adjusted conditions. The server also estimates reading time from token count and adjusts content (by truncation or insertion of summary phrases) to match the requested duration.

Output: a safety-filtered and length-adjusted story text ready for speech synthesis.

### Step 11

The server optionally performs machine translation on the story text into one or more additional languages.

Input: the adjusted story text from Step 10 and requested output language information.

The server feeds the story text into a translation model, computing context-aware representations and decoding them into target-language text. For multiple languages, the server repeats translation for each language and stores each variant.

Output: one or more target-language story texts, including the original language and any translated versions.

### Step 12

The server performs text-to-speech processing to generate audio data.

Input: the final story text for each language (from Step 10 or Step 11) and speech control parameters (speaking rate, pitch, voice type, pause positions).

The server converts the text and markup into phoneme sequences, uses an acoustic model to generate acoustic feature frames, and applies a vocoder to synthesize waveform samples. The server encodes the waveform into an audio format (for example, compressed audio) according to the target device capabilities.

Output: audio data files or streams for each language version of the story.

### Step 13

The server stores story content and prepares metadata and catalog information.

Input: the story texts and audio data from Steps 10-12.

The server assigns identifiers, language tags, age-range attributes, and thematic tags, and writes these with the audio locations into a content database or object storage. The server also updates a catalog index so that content can be efficiently retrieved by ID or attribute.

Output: stored content entries with associated catalog records.

### Step 14

The server sends the requested audio data and metadata back to the terminal.

Input: a selection of audio data and related metadata from Step 13, determined by the original request.

The server packages the audio data (or a reference to it) and metadata into a response message, sets appropriate headers, and transmits it across the communication network.

Output: a response message carrying audio content and metadata delivered to the terminal.

### Step 15

The terminal receives the response and stores the audio data locally.

Input: the response message from Step 14.

The terminal decodes the message, extracts the audio stream and related metadata (title, duration, language, attributes), and writes the audio to a file or buffer in local storage. The terminal registers an entry in a local list linking the stored audio with its metadata.

Output: locally stored audio data and a local catalog entry accessible by the application.

### Step 16

The terminal plays back the audio data to the user and manages playback control.

Input: the stored audio data and metadata from Step 15 and user playback commands.

The terminal initializes an audio player, decodes the audio stream into PCM samples, and sends the samples to an output device such as a speaker. The terminal monitors playback position and responds to user actions (play, pause, stop, volume changes) by adjusting audio output and updating internal playback state variables.

Output: audible story playback and updated playback state at the terminal.

### Step 17

The terminal records history information for future prompt generation.

Input: the attribute information from Step 1, the prompt sentence from Step 3, and identifiers for the generated content from Step 15.

The terminal stores a history record that associates the attributes, the prompt sentence, and the content ID. When the user requests another story, the terminal reads this history, modifies or extends the previous prompt sentence (for example, by adding “with new characters”), and reuses the attribute information without requiring re-entry.

Output: updated history records and a new candidate prompt basis for subsequent requests.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional content-delivery systems, a processor typically selects pre-authored stories from a static repository and performs simple playback control without deeply integrating user-specific context into the generation and rendering pipeline. Such systems do not effectively leverage user attribute information, such as age, gender, and preference information of a target person, as structured parameters for dynamically generating narrative content. As a result, these systems often provide generic, non-personalized stories that fail to optimize engagement, relaxation, and sleep-inducing characteristics for individual users. Furthermore, known systems commonly treat text generation, text post-processing, and audio synthesis as loosely coupled or independent processes, with minimal programmatic coordination across components. In particular, prompt sentences supplied to a generative model are frequently constructed in an ad hoc manner, without a systematic template-based transformation of structured user attributes into machine-consumable instructions. This leads to inconsistent story quality, unpredictable tone, and inefficient use of computational resources due to unnecessary or suboptimal generative processing.

Additionally, conventional architectures often lack an integrated distribution control mechanism that connects the generation of audio information with network-based delivery and terminal-side reproduction management. Audio data is typically streamed or downloaded without explicit control over how it is stored and sequentially reproduced at the terminal in response to reproduction control information. This separation between server-side generation and client-side playback hinders consistent user experiences and limits the ability to implement fine-grained, stateful playback behavior tailored to bedtime or relaxation scenarios.

Accordingly, there is a need for an improved computer-implemented system and method that: (i) structurally acquires and exploits user attribute information; (ii) transforms such information into a prompt sentence using template-based string processing suitable for a generative AI model; (iii) performs coordinated text post-processing on the generated story; (iv) converts the processed story into audio information; and (v) controls distribution and reproduction of the audio information across a communication network. Such a system should improve the functioning of the computer by providing a more deterministic, modular, and resource-efficient pipeline for generating, processing, and delivering personalized narrative audio content.

The specific processing by the specific processing unit 290 of the data processing device 12 in Application Example 1 is realized by the following means.

The present invention provides a server comprising a processor configured to acquire user attribute information, generate a prompt sentence on the basis of the user attribute information by performing character-string processing that combines template information with the user attribute information, supply input data including the prompt sentence to a generative information processing model to generate story information, perform text post-processing on the story information including at least one of length control, structural formatting, and removal of unnecessary information, convert the story information into audio information by a speech synthesis function, and control distribution of the audio information by transmitting the audio information via a communication network to a terminal device, causing the terminal device to store the audio information, and causing the terminal device to sequentially reproduce the audio information in accordance with reproduction control information. This enables an improvement of computer technology by providing a structured, template-driven and model-integrated processing pipeline that more efficiently transforms structured user attributes into personalized story audio, reduces ad hoc processing and variability in generative operations, and establishes coordinated server-terminal behavior for deterministic storage and playback of the generated audio content.

The term “user attribute information” refers to information indicating one or more characteristics of a target person, including at least one of age information, gender information, and preference information, and being used as structured input data for generating personalized story content.

The term “prompt sentence” refers to a character-string instruction generated on the basis of template information and user attribute information, and being supplied as part of input data to a generative information processing model in order to control generation of story information.

The term “template information” refers to predefined character-string patterns or structures that specify a general format of an instruction, and that are combined with user attribute information through string processing to produce a prompt sentence.

The term “generative information processing model” refers to a trained computational model that receives text-based input data including a prompt sentence and outputs story information by performing probabilistic or neural-network-based generation of textual content.

The term “story information” refers to text data representing narrative content generated by the generative information processing model in response to a prompt sentence, and intended to be post-processed and converted into audio information.

The term “text post-processing” refers to processing performed on story information after generation, including at least one of controlling a length of the story information, formatting a structure of the story information, and removing unnecessary information from the story information.

The term “length control” refers to an operation that adjusts the amount of text included in the story information, such as limiting or normalizing the number of characters, words, or sentences.

The term “structural formatting” refers to an operation that organizes the story information into a desired textual structure, such as adding titles, paragraphs, or section delimiters to improve readability and suitability for subsequent processing.

The term “removal of unnecessary information” refers to an operation that deletes or modifies portions of the story information that are redundant, irrelevant, or unsuitable for the intended use, such as extraneous prompts, disclaimers, or formatting artifacts.

The term “audio information” refers to digital data representing sound, including encoded or raw audio samples obtained by converting the story information through a speech synthesis function.

The term “speech synthesis function” refers to a software-implemented or hardware-implemented text-to-speech capability that transforms text data, including story information, into audio information by generating corresponding speech waveforms.

The term “distribution control” refers to processing that manages transmission, storage, and reproduction of audio information, including controlling when and how audio information is sent over a communication network and how it is reproduced by a terminal device.

The term “communication network” refers to any wired or wireless data communication infrastructure, including local area networks, wide area networks, or public networks, that enables data exchange between the server and one or more terminal devices.

The term “terminal device” refers to an information processing apparatus separate from the server, such as a mobile device, a personal computer, or a dedicated playback apparatus, that receives audio information from the server and performs storage and reproduction of the audio information.

The term “reproduction control information” refers to control data indicating how audio information is to be reproduced by the terminal device, including at least one of timing, order, start, stop, or pause conditions for sequential playback of the audio information.

In one embodiment, a server, a terminal, and a user cooperate to implement the claimed system. The server includes a processor, a memory, a non-transitory storage medium, a network interface, and one or more audio interfaces. The processor executes a program stored in the storage medium to implement modules corresponding to user attribute acquisition, prompt sentence generation, generative AI model interaction, text post-processing, speech synthesis, and distribution control. The terminal includes a processor, a memory, a display, an input interface such as a touch panel or keyboard, a speaker, and a network interface. The user operates the terminal to provide user attribute information and to listen to audio that is output by the terminal under control of the server.

The server uses general-purpose computing hardware, such as a central processing unit (CPU) based on an x86 or ARM architecture, and optionally a graphics processing unit (GPU) for neural network inference. The server executes an operating system such as a UNIX-like operating system, and an application program that is implemented, for example, using a programming language such as Python. The server uses a web application framework, such as a Python-based framework, to receive and respond to requests from the terminal via a communication network such as the Internet. The server further uses a text-to-speech software library, such as a library that provides access to platform-specific speech engines, to convert text data into digital audio information.

The server stores user attribute information in a structured form. The server represents age information, gender information, and preference information as fields of a data record or an object in memory. For example, the server may maintain in memory an internal representation such as:

age: integer

gender: enumerated type (e.g., child, boy, girl, other)

preferences: list of character strings

The server acquires such user attribute information from the terminal. The terminal displays input controls on the display, such as text fields and selection lists. The user enters data representing the age, gender, and preferences of a target person, such as a child intended to listen to the story. The terminal sends the data to the server over the network. The server receives the data, validates the data according to predefined rules (for example, checking that the age is within a predetermined range and that the preferences are character strings with a permitted length), and stores the validated data in memory in a normalized form.

The server generates a prompt sentence on the basis of the stored user attribute information. The server stores, in the storage medium, a plurality of template strings that define general structures for instructions to a generative AI model. Each template string may include placeholder tokens that represent positions at which age information, gender information, preference information, or additional control conditions are to be inserted. The server selects one of the template strings according to at least one of: the age information, the gender information, the type of story requested, or a desired emotional tone such as “calm” or “exciting.” The server performs string processing in memory to replace the placeholder tokens of the selected template with corresponding field values of the user attribute information.

For example, the server may generate a prompt sentence of the form:

“Create a bedtime story for a 5-year-old boy who likes dinosaurs and space.”

In another example, the server may generate:

“Create a gentle bedtime story for a 7-year-old girl who likes cats and magic.”

The server may further append control phrases that specify technical constraints, such as maximum length, narrative structure, and vocabulary level, such as:

“Limit the story to about 800 words and use simple sentences suitable for a young child.”

By using template-based generation of the prompt sentence, the server enforces a structured mapping from discrete user attributes to a textual instruction that a generative AI model can interpret. This mapping reduces variability in input structure and increases the predictability of the model output, thereby improving computational efficiency and stability compared to ad hoc prompt construction.

The server supplies input data including the prompt sentence to a generative AI model. In one embodiment, the generative AI model is a neural network configured as a transformer-based language model. The model uses multi-head self-attention layers, positional encodings, and stacked feed-forward sub-layers. The model has parameters (weights and biases) learned from large-scale text corpora prior to deployment. The model receives tokenized representations of the prompt sentence and processes them through multiple layers of matrix multiplications, attention calculations, and non-linear activations to produce a sequence of output tokens representing story information.

The server encodes the prompt sentence into a sequence of tokens using a tokenizer associated with the generative AI model. The server transmits the encoded sequence, along with configuration parameters such as maximum output length, temperature, and top-k or nucleus sampling parameters, to an inference engine. The inference engine may execute locally on the server's GPU or remotely on a dedicated computation system. The server or the inference engine applies a forward pass through the neural network: in each layer, the system computes attention scores between tokens, normalizes the scores, and forms weighted sums of value vectors. The system then applies feed-forward transformations and normalization operations, which are parameterized by stored weight matrices and bias vectors. At each decoding step, the system computes a probability distribution over possible next tokens. The system selects a next token according to the configured sampling algorithm and appends the selected token to the output sequence. The system repeats this process until a termination condition such as an end-of-sequence token or a length threshold is satisfied. The server converts the output token sequence back into character strings to obtain story information.

In one embodiment, the generative AI model is trained before deployment using supervised learning and fine-tuning. During training, the system minimizes a loss function such as a cross-entropy loss between predicted token distributions and ground-truth continuation tokens in training sequences. The system updates the network parameters by computing gradients of the loss with respect to the parameters through backpropagation and performing weight updates using an optimization algorithm such as stochastic gradient descent or an adaptive variant. The system enhances generalization and robustness through data augmentation techniques, such as adding synthetic prompts with varied attribute combinations or perturbing sentence structures while preserving semantic content. Although training is performed separately from the server's real-time operation, the trained model structure, the loss-driven parameter optimization, and the tokenizer are integrated into the runtime inference pipeline that the server uses.

The server uses distinct internal representations for user attribute information, prompt sentences, and story information. The server stores user attribute information in structured records and converts these records into prompt sentences through deterministic string operations. The server then uses token sequences as inputs to the generative AI model. The server thus implements a multi-stage data flow that includes (i) structured-to-text transformation, (ii) text-to-token transformation, (iii) token-based neural computation, and (iv) token-to-text reconstruction. This multi-stage design provides technical improvements in modularity and error isolation. For example, if a prompt sentence deviates from expected length or format, the server can detect the deviation before tokenization and adjust templates or attributes, avoiding wasted neural inference cycles and reducing computational load.

After generating the story information, the server performs text post-processing. The server stores the story information as a character string in memory. The server applies a sequence of transformations including at least one of length control, structural formatting, and removal of unnecessary information.

For length control, the server analyzes the number of characters or tokens and, if the length exceeds a target threshold, truncates the text at a sentence boundary or instructs the generative model to regenerate with a reduced maximum length. The server may calculate a complexity score based on average sentence length or vocabulary rarity and adjust the content to maintain a desired complexity interval for the target age group. This provides a technical effect of controlling processing and storage requirements and ensuring that the audio generation module receives text of manageable size, thereby reducing synthesis time and memory usage.

For structural formatting, the server inserts paragraph breaks at certain positions, such as after a certain number of sentences or after scene changes indicated by keywords. The server may add a title at the beginning, for example, “The Little Dinosaur in Space,” derived from extracted entities in the story or from a separate generation step. The server can represent the story as a data structure with separate fields for title, paragraphs, and metadata. This structure supports efficient navigation, caching, and partial regeneration of segments in later operations.

For removal of unnecessary information, the server scans the story for content that is not relevant to the target use, such as meta-discourse, disclaimers, or text that reflects instructions rather than story content. The server identifies such text segments using pattern matching, keyword detection, or classification models and deletes or replaces them. This prevents non-story text from being synthesized to audio, which reduces cognitive load for the listener and aligns resource usage with intended content.

The server converts the story information into audio information using a speech synthesis function. The server invokes a text-to-speech engine that maps characters or phonetic units to digital audio samples. The text-to-speech engine may use concatenative synthesis, parametric synthesis, or neural-network-based synthesis. In one example, the engine uses parametric synthesis based on statistical models of speech units and generates waveforms using vocoder techniques. In another example, the engine uses a neural network model such as a sequence-to-sequence model that predicts mel-spectrograms from text sequences, followed by a vocoder model such as a convolutional neural network that generates raw waveforms from spectrograms.

The server selects the voice profile, speaking rate, and intonation pattern based on the user attribute information and stored configuration rules. For a young child, the server sets a slower speaking rate and smoother intonation to promote relaxation. The server passes the processed story text to the text-to-speech engine and receives a stream of audio samples in return. The server encodes these samples into an audio file format such as a waveform audio file or a compressed audio file format, and stores the resulting file on a storage device.

The server controls distribution of the audio information to the terminal. The server associates each audio file with metadata such as user identifier, timestamp, story identifier, and length. The server maintains a data structure such as a queue or playlist of audio items for each user or terminal. In response to a distribution request or as part of a predetermined schedule, the server selects appropriate audio information and transmits the corresponding file or a stream of audio data to the terminal through a communication network.

The server also sends reproduction control information to the terminal. The reproduction control information may specify playback order, start and stop positions, and whether to loop certain sections. The terminal receives the audio information and the reproduction control information, stores the audio information in a local storage, and uses a media playback component to reproduce the audio. The terminal performs operations such as buffering, decoding, and rendering the audio through the speaker. By delegating storage and playback to the terminal under guidance from the server, the system reduces network load and allows the server to manage multiple terminals efficiently.

The server improves computer technology in several ways. The template-based prompt sentence generation reduces entropy in the inputs to the generative AI model, which results in more predictable model behavior and reduced variance in story length and structure. This predictability enables the server to allocate CPU, GPU, and memory resources more efficiently and to schedule inference requests in a way that reduces peak load and latency. The explicit post-processing pipeline serves as an intermediate layer that normalizes and filters model outputs so that downstream modules, including the text-to-speech engine and the distribution module, receive well-formed inputs. This reduces error propagation, minimizes failed synthesis attempts, and decreases the need for repeated inference runs, thus improving overall throughput.

The server implements non-conventional processing rules for mapping user attributes to prompt sentences. Unlike human authors or simple template-fill systems, the server uses a combination of structured attribute evaluation, rule-based template selection, and dynamic constraint injection. For example, the server can maintain a rule table that associates ranges of age information with maximum story length, vocabulary complexity levels, and narrative pacing profiles. The server uses this rule table to select or modify template structures so that the prompt sentence contains explicit machine-readable constraints, thereby influencing the internal attention patterns of the generative AI model in a way that is not achievable through unstructured human instructions.

The server further uses specific parameter settings and selection algorithms in the generative AI model to ensure both diversity and control. For example, the server may adapt the temperature and sampling strategy according to the user attribute information and the length of the prompt sentence, so that for younger children, the server uses lower temperature and narrower sampling to avoid overly complex or unpredictable plot developments. This adaptation is computed algorithmically from the structured attributes and previous outputs, and it changes the probability distribution over next-token choices in a way that reduces the likelihood of out-of-scope stories, which in turn reduces the need for rejection or regeneration cycles.

The system provides additional technical effects in data management and communication efficiency. The server caches intermediate results such as prompt sentences and post-processed story information. If repeated requests from the same user with similar attribute patterns are received, the server can reuse existing data without re-running the generative AI model, thereby saving computation time and network bandwidth. The server also supports segmentation of audio information into smaller units, enabling the terminal to prefetch only the next segment of the story while playing the current one. This segmented distribution reduces latency perceived by the user and smooths network utilization.

In another embodiment, the server executes a variant of the generative AI model tailored to specific languages or domains. The server may maintain multiple models or sub-models and select among them based on the user attribute information and language preference. The server can, for example, generate story information in a first language and then apply a separate translation model that is also implemented as a neural network trained with sequence-to-sequence architectures. The server performs translation at the text level prior to speech synthesis, and then converts the translated text to audio using a language-specific text-to-speech engine. This embodiment further illustrates the modular data flow and emphasizes that each transformation is technically constrained and optimized.

In still another embodiment, the server includes monitoring and feedback modules. The terminal may transmit usage logs, including playback duration and user interaction events such as pausing or stopping at particular points. The server aggregates such data and adjusts prompt generation rules and model parameters, for example by modifying the rule table or by updating sampling strategies. When retraining or fine-tuning the generative AI model, the server uses collected usage data to define new loss terms or weighting factors in the error function, such as penalizing story continuations that correspond to frequent early stops. This closed-loop adaptation further improves the match between generated content and user engagement patterns, which can be measured in terms of reduced early termination events and increased story completion rates.

The terminal, in all embodiments, acts not only as an input/output device but also as a controlled playback node. The server uses reproduction control information to manage timing and sequence of playback, for example to ensure that the story begins after a pre-defined quiet period or that the volume ramps down towards the end of the story. These behaviors contribute to promoting sleep and relaxation in a repeatable and tunable manner. The systematic coordination between server-side generation and terminal-side playback, implemented by explicit data structures and control messages, thus provides a technical improvement over systems in which audio delivery is simply a file download without integrated reproduction control.

Through these embodiments and their variations, the server, the terminal, and the user cooperate in a pipeline where structured user attributes are algorithmically transformed into carefully controlled prompt sentences, which are then processed by a defined generative AI model architecture, post-processed into normalized story text, transformed into audio using text-to-speech algorithms, and distributed and reproduced under explicit technical control. This configuration yields improvements in processing efficiency, output stability, data management, and user experience that go beyond simple automation of human storytelling.

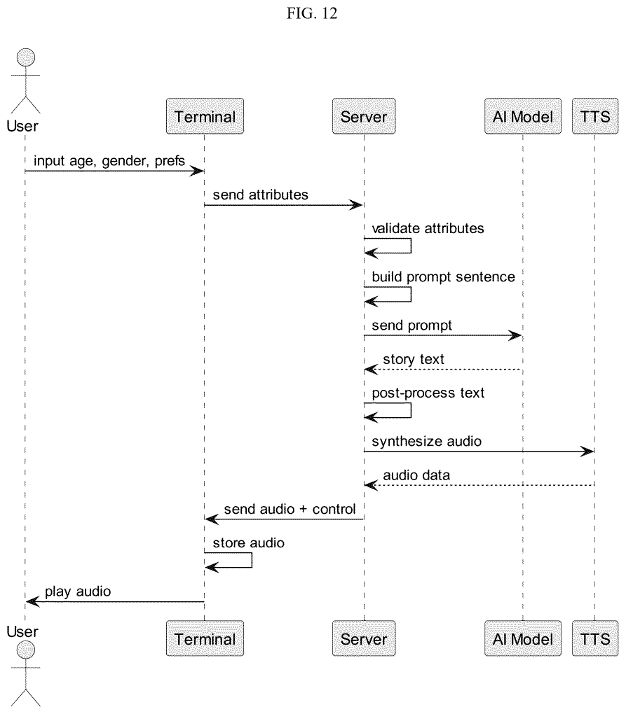

The following describes the processing flow using FIG. 12.

### Step 1

The user operates the terminal to input user attribute information.

The terminal displays input fields for age, gender, and preferences on a display device.

The user enters values such as “5” for age, “boy” for gender, and “dinosaurs, space” for preferences.

Input: raw key and touch events from the user, and previously displayed input form.

Processing: the terminal converts the raw events into structured data by mapping each field on the screen to an internal variable (for example, age, gender, preferences) and normalizes the data (for example, trimming spaces, splitting preference strings by commas).

Output: a structured user attribute object in the terminal's memory that includes age, gender, and a list of preference strings.

### Step 2

The terminal sends the structured user attribute object to the server.

The terminal serializes the user attribute object into a text-based message (for example, JSON) and wraps it in a network request.

Input: structured user attribute object produced in Step 1.

Processing: the terminal encodes the object into a character string representation, attaches headers indicating content type and endpoint, and uses a network interface to transmit the message over a communication network.

Output: a network message containing encoded user attribute information delivered to the server.

### Step 3

The server receives and validates the user attribute information.

The server accepts the incoming network message through a network interface and passes it to an application program.

Input: encoded user attribute information from Step 2.

Processing: the server decodes the message into internal variables, checks data types and ranges (for example, confirming that age is within a predetermined range and that preference entries are not empty), and discards or corrects invalid data according to predefined validation rules.

Output: a validated and normalized user attribute record stored in server memory, ready for prompt sentence generation.

### Step 4

The server generates a prompt sentence based on the user attribute record.

The server selects a template string according to the age, gender, and context of use.

Input: validated user attribute record from Step 3 and stored template strings.

Processing: the server substitutes placeholders in the chosen template with concrete attribute values by performing string concatenation and replacement operations, and may append control clauses indicating constraints such as tone or length.

Output: a complete prompt sentence in natural language, for example, “Create a bedtime story for a 5-year-old boy who likes dinosaurs and space.”

### Step 5

The server converts the prompt sentence into tokenized input for the generative AI model.

The server uses a tokenizer compatible with the generative AI model to transform the character sequence into a sequence of integer token identifiers.

Input: the prompt sentence from Step 4.

Processing: the server scans the prompt sentence, segments the text according to the tokenizer's vocabulary, maps each segment to a corresponding token identifier, and assembles the identifiers into an ordered array.

Output: a token sequence representing the prompt sentence in a form suitable for input to the generative AI model.

### Step 6

The server generates story information using the generative AI model.

The server supplies the token sequence to a transformer-based language model that is stored in a model execution environment.

Input: token sequence from Step 5 and model parameters stored in memory.

Processing: the server performs neural network inference by executing matrix multiplications, attention operations, and non-linear transformations layer-by-layer; at each decoding step, the server computes a probability distribution over possible next tokens, selects a next token based on configured sampling parameters, and appends it to the output sequence until a termination condition is met.

Output: a generated sequence of tokens that encodes the story content.

### Step 7

The server reconstructs story text from the generated token sequence.

The server applies a detokenization procedure to convert each token identifier back to its textual representation.

Input: generated token sequence from Step 6.

Processing: the server maps each token identifier to its corresponding subword or character sequence and concatenates these segments into a coherent story string while inserting necessary spacing and punctuation.

Output: story information in the form of natural-language text stored in server memory.

### Step 8

The server performs text post-processing on the story information.

The server refines the structure and length of the story to satisfy predetermined technical constraints.

Input: raw story text from Step 7.

Processing: the server measures story length, truncates or regenerates portions if necessary, inserts paragraph breaks and a title, and removes unwanted segments such as residual instruction-like text by applying pattern matching, rules, and optional classification models.

Output: cleaned and formatted story text that is optimized for subsequent text-to-speech conversion.

### Step 9

The server converts the processed story text into audio information via a speech synthesis function.

The server invokes a text-to-speech module to map textual content into digital audio samples. Input: cleaned and formatted story text from Step 8.

Processing: the server splits the text into synthesis units, converts each unit into phonetic representations, generates acoustic parameters or spectrograms, and creates a waveform through a synthesis algorithm or vocoder; the server encodes the waveform into an audio file format suitable for transmission.

Output: an audio file or audio stream that encapsulates the spoken version of the story.

### Step 10

The server prepares distribution control information and associates it with the audio information.

The server defines how and in what order the audio information is to be reproduced by the terminal.

Input: audio information from Step 9 and system configuration data.

Processing: the server creates control metadata that includes playback order, start and stop positions, and optional volume ramp profiles, and binds this metadata to identifiers that also reference the audio file.

Output: a distribution package that comprises references to audio information and corresponding reproduction control information.

### Step 11

The server transmits the audio information and distribution package to the terminal.

The server uses the network interface to send data to the terminal over a communication network.

Input: distribution package from Step 10 and the corresponding audio file.

Processing: the server forms one or more network messages that contain the audio data and metadata, sets appropriate headers for content type and length, and delivers the messages according to a transfer protocol.

Output: received audio data and reproduction control information at the terminal side.

### Step 12

The terminal stores the received audio information and prepares for playback.

The terminal writes the audio data into local storage or memory and parses reproduction control information.

Input: audio data and reproduction control information from Step 11.

Processing: the terminal checks integrity of the received file, indexes the file by identifiers, and configures a media playback component with parameters such as playback order and start time derived from the control information.

Output: a locally stored audio resource and a configured playback state ready to be triggered.

### Step 13

The terminal reproduces the audio information according to the reproduction control information.

The terminal activates a media player that decodes the stored audio file and outputs sound.

Input: stored audio file and configured playback state from Step 12.

Processing: the terminal decodes audio frames, manages buffering and timing, applies any volume or timing adjustments specified in the reproduction control information, and sends audio samples to a speaker device.

Output: audible playback of the personalized story to the user, under controlled timing and sequence.

### Step 14

The user listens to the reproduced audio and may provide further interaction.

The user hears the bedtime story through the terminal's speaker and may issue commands such as pause, resume, or request for a new story.

Input: audio playback from Step 13 and user actions on input controls.

Processing: the terminal converts user actions (for example, button presses) into control commands and sends corresponding requests to the server when a new story is desired, causing repetition of earlier steps with updated user attribute information.

Output: new user attribute data or control signals that can re-initiate the processing pipeline for another story generation cycle.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content-generation systems that utilize machine learning models typically treat natural language generation, language translation, audio rendering, and electronic distribution as separate and loosely coupled functionalities. Such systems often rely on manually crafted prompts, fixed model parameters, and independent post-processing pipelines, which leads to several technical problems in computer technology.

First, conventional systems impose significant overhead on a server in orchestrating multiple disjoint services for text generation, multilingual translation, format conversion, and audio synthesis. This results in redundant data transfers between subsystems, repetitive parsing and reformatting of text data, and inefficient utilization of processing resources and network bandwidth. Consequently, latency increases and throughput in processing user requests decreases.

Second, conventional systems generally lack a unified mechanism to generate and manage story data and translated story data in association with user attributes and emotional states. Prompt sentences are rarely optimized by the system itself based on user attribute information or user input information, and control parameters of a generative AI model are usually static. As a result, server-side computation cannot be adaptively tuned to the user context, causing unnecessary computation for irrelevant content while failing to allocate computational resources efficiently for content that better matches the user's needs.

Third, many existing implementations do not maintain a structured, queryable association between generated story data, translated story data, and distribution digital data across different formats and languages. This leads to inefficient database operations when a server retrieves content based on language type, target age group, story genre, or distribution format. Such inefficiencies manifest as increased database access latency, non-optimal indexing strategies, and difficulties in scaling content retrieval as the number of generated stories grows.

Fourth, traditional architectures for electronic content sale frequently bolt payment processing onto the content pipeline as a separate layer, forcing multiple round trips and duplicate validation steps between sale logic and content-access logic. This separation yields additional transaction overhead, complex error handling, and increased risk of inconsistent state between payment records and content-access permissions.

Fifth, existing solutions provide limited technical integration between analysis of user emotional state and real-time control of content generation and progression. Emotional analysis, if present, is often handled as an external analytics feature rather than as a direct input to the generative AI model and prompt construction. As a result, a server cannot directly reconfigure model parameters, prompt sentences, or story structure to improve computational efficiency and personalization in a closed feedback loop.

Therefore, there is a need for a system that technically improves the functioning of computer-based content generation and distribution by: (i) unifying acquisition of user attribute information and user input information with automatic generation of prompt sentences; (ii) coordinating, on a server, integrated pipelines for generative AI processing, multilingual translation, format conversion, and audio synthesis; (iii) efficiently managing and querying story data and translated story data in a structured management database; and (iv) embedding payment processing and emotional-state feedback directly into the server's control logic so as to reduce redundant computation, lower latency, and increase overall system throughput.

The specific processing by the specific processing unit 290 of the data processing device 12 in Example 2 is realized by the following means.

The present invention provides a server comprising a processor that is configured to acquire user attribute information and user input information, to generate a prompt sentence based on the user attribute information and the user input information, to input the prompt sentence to a generative AI model, to cause the generative AI model to automatically generate story data in a text format based on the prompt sentence, to store the story data in a storage device, to convert the story data into translated story data in a plurality of languages by using a translation program or a translation service, to store the translated story data in the storage device in association with respective language types, to convert at least one of the story data and the translated story data into distribution digital data in at least one of an electronic book format, a document format, and a web content format, to distribute the distribution digital data to a terminal device via a communication network, to convert at least one of the story data and the distribution digital data into audio data by using a speech synthesis program, to transmit the audio data to the terminal device so that a user can audibly perceive the story, to execute electronic sale processing of at least one of the story data and the distribution digital data by using a payment processing program, and to provide, to a purchasing user, at least one of an access right and download identification information for the at least one of the story data and the distribution digital data, and further configured to analyze an emotional state of the user based on at least one of biometric information, operation history information, and voice information of the user, to dynamically adjust at least one of content and progression of the story by changing at least one of content of the prompt sentence, control parameters of the generative AI model, and components of the story data in accordance with the emotional state, and to store and retrieve the story data and the translated story data from a management database based on at least one of language type, target age group, story genre, and distribution format. This enables technical improvements to computer functionality by reducing redundant inter-service communication, optimizing use of processing and storage resources through context-aware control of the generative AI model and translation pipeline, lowering response latency in retrieving and distributing multi-format, multilingual content, and providing an integrated, feedback-driven content generation architecture in which emotional-state analysis, electronic sale processing, and content access control are coordinated within a unified server-side control flow.

The term “user” refers to a person or entity that operates a terminal device to interact with the system, including providing input information, receiving generated content, and optionally performing purchase operations.

The term “terminal device” refers to an information processing apparatus, such as a mobile device, a tablet device, a personal computer, or a similar computing device, that communicates with the server via a communication network to send requests and receive content.

The term “server” refers to an information processing apparatus, or a group of cooperating apparatuses, that includes at least one processor and at least one storage device and that executes the functions of acquiring information, generating content, translating content, converting formats, synthesizing audio, and controlling electronic sales.

The term “processor” refers to one or more hardware processing units, such as a central processing unit, a graphics processing unit, or a programmable logic device, that execute instructions to implement the functions attributed to the server in the present invention.

The term “storage device” refers to any non-transitory computer-readable medium, including a semiconductor memory, a magnetic storage medium, or an optical storage medium, that stores program code, story data, translated story data, management data, and other related information.

The term “user attribute information” refers to information associated with characteristics of the user, such as age group, gender, preference category, language preference, or other profile-related attributes used by the server to tailor content generation.

The term “user input information” refers to information explicitly provided by the user through the terminal device, including a prompt sentence, selection of story parameters, language choices, and other interactive inputs for controlling content generation.

The term “prompt sentence” refers to a text string generated based on user attribute information and user input information, which is supplied as an input condition to a generative AI model so as to specify a theme, style, structure, or other aspects of a story to be generated.

The term “generative AI model” refers to a trained machine learning model, such as a neural network language model, that receives the prompt sentence as an input and automatically generates story data in a text format through internal computational operations.

The term “story data” refers to text data representing a narrative, including, for example, sentences, paragraphs, and structured sections, generated by the generative AI model based on the prompt sentence.

The term “translated story data” refers to text data obtained by converting the story data from a source language into one or more target languages using a translation program or a translation service.

The term “translation program” refers to software executed on the server or on an associated computing resource that performs machine translation of text from one language into another language.

The term “translation service” refers to a network-accessible translation function provided by an external system or platform, which receives text from the server and returns translated text in one or more target languages.

The term “language type” refers to an identifier associated with a natural language, such as an ISO language code or an internally defined language identifier, used to distinguish versions of story data or translated story data.

The term “distribution digital data” refers to data generated by converting at least one of the story data and the translated story data into a format suitable for distribution, including at least one of an electronic book format, a document format, and a web content format.

The term “electronic book format” refers to a structured digital document format suitable for electronic reading, such as a format that organizes text, images, and metadata for use by electronic readers or reading applications.

The term “document format” refers to a digital file format for representing textual content, optionally with images and layout information, such as a general-purpose text document or page-description format.

The term “web content format” refers to a digital content format suitable for presentation through a web browser or web-based application, including markup language data, style data, and associated resources.

The term “audio data” refers to digital data representing sound, including synthesized speech that audibly presents at least a portion of the story data or the distribution digital data.

The term “speech synthesis program” refers to software that converts text into audio data representing speech, by performing text analysis, phonetic conversion, and signal generation or similar processing.

The term “payment processing program” refers to software that executes electronic sale processing, including communicating with payment services, verifying transaction information, and updating purchase records.

The term “electronic sale processing” refers to a sequence of operations by which the server handles purchase requests, performs payment authorization and settlement, and associates purchased content with a purchasing user.

The term “access right” refers to permission information that allows a user to obtain or view at least one of the story data and the distribution digital data through the system after completion of a purchase.

The term “download identification information” refers to data, such as a token, a link, or an identifier, that enables a user to download at least one of the story data and the distribution digital data from the server or from a storage service.

The term “biometric information” refers to data related to physiological or behavioral characteristics of the user, such as heart rate, facial expression characteristics, or voice features, that can be used to infer an emotional state.

The term “operation history information” refers to data representing past user operations on the terminal device or within the system, such as input sequences, interaction timing, and selection history.

The term “voice information” refers to audio data representing speech or utterances of the user, which can be analyzed for emotional state, content, or other characteristics.

The term “emotional state” refers to a condition associated with user emotion, such as excitement, boredom, satisfaction, or frustration, inferred from at least one of biometric information, operation history information, and voice information.

The term “control parameters of the generative AI model” refers to configuration values that influence operation of the generative AI model, such as temperature, maximum output length, sampling method, or stylistic constraints.

The term “components of the story data” refers to structural or semantic elements of the story, such as characters, scenes, plot segments, narrative perspective, or difficulty level, which can be modified or selected by the server.

The term “management database” refers to a structured data storage system that maintains associations between story data, translated story data, user-related information, and distribution-related metadata, enabling search and retrieval based on specified criteria.

The term “target age group” refers to a classification indicating an age category of intended readers or listeners, such as a range expressed in years or a categorical label, which can be used as a search or generation parameter.

The term “story genre” refers to a classification of narrative type, such as mystery, fantasy, science fiction, or adventure, used to characterize, generate, or retrieve story data.

The term “communication network” refers to a wired or wireless data communication infrastructure, including local area networks, wide area networks, and public networks, that enables data exchange between the server and terminal devices.

In one exemplary embodiment, a server, a terminal, and a user cooperate to implement the claimed system. The server includes at least one processor, at least one storage device, a network interface, and optionally a hardware accelerator such as a graphics processing unit. The terminal includes at least one processor, a display unit, an input unit, a communication interface, and optionally audio output hardware such as a speaker or headphone interface. The user operates the terminal to interact with the server.

The server executes an operating system and middleware capable of running application software, such as a web server program, an application server program, a database management system, a translation program, a speech synthesis program, and a payment processing program. For example, the server executes a general-purpose operating system, uses a relational or non-relational database management system in the storage device, and employs a machine translation engine and a text-to-speech engine as separate software modules. The server further executes a generative AI model framework implemented using a machine learning library on top of a hardware accelerator.

The server stores, in the storage device, program modules that implement functions for acquiring user attribute information and user input information, generating a prompt sentence, invoking a generative AI model, storing story data, invoking a translation program or translation service, managing translated story data, converting story data to distribution digital data, synthesizing audio data, controlling electronic sale processing, and analyzing an emotional state of the user.

The terminal executes a web browser or a dedicated application that communicates with the server via a communication network such as a packet-switched network. The terminal presents graphical user interface components, including text input fields, selection menus, and buttons, for receiving user attribute information and user input information. The terminal transmits these pieces of information to the server in a structured message format through a secure transport protocol.

The user operates the terminal to provide at least the user input information. The user may input a free-form text describing desired story characteristics, and may select options representing user attribute information. The user may, for example, select an age group, a preferred genre, and a language preference through on-screen controls of the terminal. The user may enter a prompt sentence directly or may provide partial instructions that are used by the server to automatically construct a prompt sentence.

The server receives the user attribute information and the user input information from the terminal and stores them in a management database in association with a user identifier. The server represents the user attribute information and the user input information using defined data structures. For instance, the server stores the user attribute information in a record that includes fields such as age_group, preference_category, and base_language, and stores the user input information in a record that includes fields such as free_text_instruction and option_selection.

The server then generates a prompt sentence using a prompt-construction module. The prompt-construction module executes deterministic algorithms that combine canonical text templates with the stored user attribute information and user input information. For example, the server may concatenate a base template for a story request with parameterized clauses indicating age group, genre, desired length, and tone. This prompt sentence is thus automatically derived from structured data, rather than being only manually authored by the user. The server may, for instance, generate prompt sentences such as:

“Create an adventure story about a future city for children aged 10, with a happy ending and about 2,000 words.”

“Generate a mystery story set in a quiet mountain village, written in a suspenseful tone, including at least three major plot twists, about 2,500 words.”

“Write a fantasy story for children aged 8-10 in simple language, about a girl who discovers a secret forest, including clear moral lessons on friendship and courage.”

“Create a sci-fi story set on a space station orbiting Jupiter, with realistic scientific elements and detailed descriptions of daily life on the station, about 4,000 words.”

The server uses the generated prompt sentence as an input to a generative AI model. In one embodiment, the generative AI model is implemented as a transformer-based neural network language model. The server stores, in the storage device, model parameters including token embeddings, positional encodings, and weight matrices for multiple attention layers and feed-forward layers. The server executes model inference by loading these parameters into memory and performing matrix multiplication, normalization, and non-linear activation operations on numerical representations of the prompt sentence.

The server converts the prompt sentence into a sequence of tokens using a tokenizer module. The server maps each token to an embedding vector and feeds the sequence of vectors into stacked transformer layers. Each transformer layer performs multi-head self-attention, computing attention scores using learned query, key, and value weight matrices, and then aggregates contextual information across the entire token sequence. The server applies learned feed-forward sub-networks to the outputs of the attention layers, and applies layer normalization and residual connections as specified by the model architecture. The server repeatedly applies these operations across multiple layers, thereby computing contextualized representations for each token position.

The server then uses a decoding algorithm, such as greedy decoding, top-k sampling, or nucleus sampling, to sequentially generate output tokens that constitute story data. The server configures the decoding algorithm through control parameters, including temperature, maximum number of tokens, and sampling thresholds. The server adjusts these control parameters based on the user attribute information and the user input information so that the generated story data matches the intended length, complexity, and style. The server thereby performs a non-trivial optimization of model behavior that goes beyond manual human prompting, improving the relevance and consistency of content while reducing the need for repeated generation attempts.

The server stores the generated story data in a story table in the management database. The server associates the story data with metadata such as a story identifier, the user identifier, the language type of the story data, and the prompt sentence. The server may also store structural annotations, such as chapter boundaries and section indices, as part of the story data, thereby enabling efficient subsequent processing and retrieval based on internal structure as well as metadata.

The server then invokes a translation program or accesses a translation service to convert the story data into translated story data in multiple languages. In one embodiment, the server executes a neural machine translation model locally, which is also implemented as a transformer-based sequence-to-sequence architecture. In another embodiment, the server communicates with an external translation service via a programmatic interface. In either case, the server constructs translation requests by including the story data, the source language type, and target language types, and receives translated text as responses.

The server stores each instance of translated story data in a translation table of the management database, associating each translation with the corresponding story identifier and language type. The server maintains indexes in the database on fields such as story identifier, language type, target age group, and story genre. By organizing the data using this structured schema, the server can perform indexed queries to retrieve story data and translated story data efficiently, which results in reduced access time and improved scalability of the system.

The server converts at least one of the story data and the translated story data into distribution digital data. For example, the server may use a document generation module that formats the text data according to an electronic book specification or a document layout specification.

The server may insert markup tags, style information, and table-of-contents structures into the distribution digital data. The server may also generate hyperlinked web content, including markup and style sheets, to render the story as web content on the terminal.

The server further executes a speech synthesis program to convert at least one of the story data and the distribution digital data into audio data. The server may implement the speech synthesis program using a neural text-to-speech model that includes an acoustic model and a vocoder. The server converts the text content into phoneme sequences or linguistic features and then generates waveform samples by executing a neural network that maps these features to audio signals. The server can thus generate high-quality synthesized speech that is adapted to the language type and possibly to user preferences, such as speaking rate and prosody.

The server controls electronic sale processing using a payment processing program. The server receives purchase requests from the terminal, validates the identity of the user, and communicates with an external payment service to authorize and settle a transaction. The server stores purchase records in the management database and generates access rights or download identification information associated with the purchased story data or distribution digital data. The server enforces access control by checking these rights when the terminal requests story data, translated story data, or distribution digital data.

The server may analyze an emotional state of the user based on biometric information, operation history information, or voice information transmitted from the terminal. The terminal may, for example, send time-series data corresponding to interaction delays, scrolling behavior, or speech segments, which the server processes using classification algorithms. In one embodiment, the server uses a trained neural classifier that receives feature vectors derived from the biometric information, operation history information, and voice information, and outputs an emotional state label. The server then adjusts the prompt sentence, the control parameters of the generative AI model, or the components of the story data based on the inferred emotional state. For example, if the server determines that the user exhibits a bored state, the server may increase story pacing by altering desired length or by increasing a parameter that favors more eventful content in the generative process. This feedback-driven control loop changes computational behavior of the generative AI model dynamically, thereby improving the technical performance of the system in terms of convergence speed to satisfactory content and reducing the number of generation iterations.

The server thus implements specific data structures and algorithms that yield technical advantages. By automatically generating the prompt sentence using structured user attribute information and user input information, the server reduces manual trial-and-error prompt formulation and decreases failed or suboptimal generations. This leads to fewer model invocation cycles and thereby lowers processing load and reduces latency. By storing story data and translated story data in a normalized database schema with carefully selected indexes, the server reduces input/output overhead and enables scalable retrieval across diverse search criteria including language type, target age group, story genre, and distribution format.

Moreover, the server integrates the generative AI model, translation program, format conversion, and speech synthesis program into a unified processing pipeline. This integration eliminates redundant parsing, reformatting, and repeated data transfer between disjoint subsystems. The server passes internal identifiers and structured metadata along the pipeline, avoiding repeated tokenization or re-encoding of text. As a result, the total computational cost for multiple-stage processing is reduced, and throughput is increased. These are concrete improvements in computer technology rather than mere automation of human creative tasks. The generative AI model itself is trained in advance using a large corpus of text data and optimized using a learning algorithm such as stochastic gradient descent with an error function defined as a negative log-likelihood of target tokens. During training, the server, or a training system, repeatedly computes forward passes through the transformer network, computes gradients of the error function with respect to the model parameters using backpropagation, and updates the parameters using an optimizer such as Adam. The training process may employ data augmentation strategies, such as masking of tokens or randomization of sentence order, to improve generalization. Although this training may be performed offline, the resulting learned parameters and architecture are concretely specified and used during inference, ensuring that the generative AI model operates according to a defined algorithmic structure.

The server extends beyond conventional human storytelling by embedding internal rules and non-conventional processing sequences. For instance, the server may enforce constraints on narrative structure by post-processing generated story data using rule-based filters that check for presence of required story components, such as introduction, conflict, and resolution segments, and then refine or regenerate only missing or inconsistent segments. The server may also maintain a cache of previously generated story data fragments and reuse them through algorithmic selection and recombination when similar prompt sentences are received. These internal mechanisms are executed entirely within the computing system and are not mere reflections of human editorial processes.

The terminal, in turn, benefits from these server-side improvements. The terminal receives pre-structured content, translated story data, and audio data in optimized formats, reducing the amount of local processing required. The terminal may cache content segments based on metadata, such as language type and target age group, and present user interfaces that allow rapid switching between translated story data without additional server round trips. This reduces communication load and improves responsiveness from the user's perspective. In another embodiment, multiple servers are deployed in a distributed architecture. One server may specialize in generative AI model inference using high-performance hardware accelerators, another server may specialize in translation processing, and another server may act as a front-end server handling user sessions and database access. These servers exchange structured messages containing story identifiers and metadata, rather than raw text, to minimize data transfer volume. This distributed design further increases scalability and resilience, and the explicit separation of roles permits dedicated optimization of each subsystem while preserving the unified logical pipeline defined in the claims.

Alternative embodiments may vary the internal neural network architecture of the generative AI model, such as using recurrent networks with attention mechanisms instead of transformer-only architectures, or may use different decoding strategies or control parameter configurations. The server may also utilize different types of speech synthesis models, such as unit-selection synthesis or concatenative synthesis, in place of neural text-to-speech, depending on available computational resources. Similarly, the translation program may be implemented using statistical machine translation or hybrid models.

In each embodiment, however, the server, the terminal, and the user cooperate according to the claimed configuration: the server generates a prompt sentence based on user attribute information and user input information; the server invokes a generative AI model to create story data; the server translates and formats the story data into multiple technical representations; the server synthesizes audio data and performs electronic sale processing; and the server maintains a structured management database that permits efficient retrieval. These coordinated, technically specific operations result in improved processing efficiency, reduced latency, and enhanced manageability of multi-language, multi-format story generation in a manner that concretely improves the functioning of the computer system itself.

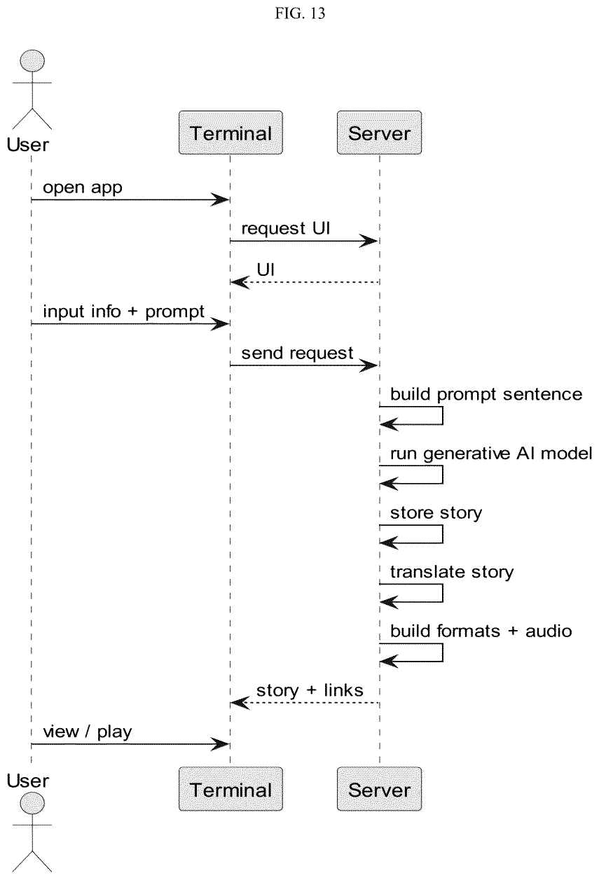

The following describes the processing flow using FIG. 13.

### Step 1

User operates the terminal to launch an application or web browser and to access the server over a communication network.

Terminal sends a request to the server for a story-generation interface as input.

Server returns a user interface description as output, including fields for user attribute information and a prompt sentence.

### Step 2

User inputs user attribute information, such as age group, preferred genre, and base language, using controls displayed on the terminal.

User also inputs user input information, such as a free-text description of desired story characteristics or a direct prompt sentence.

Terminal collects the user attribute information and the user input information as input data and converts them into a structured message format.

Terminal sends the structured message to the server as output, for example as a JSON payload over HTTPS.

### Step 3

Server receives the structured message from the terminal as input and validates the data fields, checking for required items such as age group, base language, and story length.

Server performs data processing by mapping the received values into internal data structures, such as records containing user_id, age_group, preference_category, and free_text_instruction.

Server stores these records in a management database and generates a unique request identifier as output.

### Step 4

Server reads the stored user attribute information and user input information from the management database as input.

Server executes a prompt-construction module that applies deterministic rules and template-based text generation to combine the attribute values and input instructions.

Server performs string concatenation, placeholder replacement, and conditional insertion of phrases based on the attribute values to produce a grammatically consistent prompt sentence.

Server outputs the generated prompt sentence and stores it in association with the request identifier in the management database.

### Step 5

Server takes the prompt sentence as input and applies a tokenizer module to segment the sentence into tokens.

Server maps each token to an integer identifier and then to a corresponding embedding vector using an embedding matrix stored in memory.

Server outputs a token sequence and an embedding vector sequence that represent the prompt sentence numerically.

### Step 6

Server inputs the embedding vector sequence into a generative AI model implemented as a transformer-based neural network.

Server performs data computation by executing multi-head self-attention, matrix multiplications, layer normalization, and feed-forward operations across multiple stacked layers on a processor or a hardware accelerator.

Server computes contextualized hidden states for each token position, propagates them through the model, and applies a decoding algorithm such as top-k sampling or nucleus sampling to generate new output tokens one by one.

Server converts the generated tokens back into text to obtain story data in the base language as output and stores the story data in the management database linked to the request identifier.

### Step 7

Server receives the story data from the management database as input for translation.

Server determines target language types, such as English, Chinese, and Spanish, based on system configuration or user selection.

Server constructs translation requests that include the story text, the source language type, and each target language type, and sends these requests to a translation program or translation service.

Server receives translated text strings as output for each target language and stores each translated story data record in a translation table with fields for story_id and language_type.

### Step 8

Server reads the story data and the translated story data from the management database as input for format conversion.

Server applies a format-conversion module that parses the text, splits it into structural units such as chapters and paragraphs, and inserts markup elements corresponding to an electronic book format, a document format, or a web content format.

Server generates distribution digital data, such as an e-book file, a document file, or web markup files, by assembling text and metadata according to predefined schemas.

Server stores these distribution digital data objects in storage and outputs identifiers or file paths associated with each format and language type.

### Step 9

Server takes at least one of the story data and the distribution digital data as input for speech synthesis.

Server passes the text content to a speech synthesis program, which performs text normalization, phoneme conversion, and prosody estimation, and then executes a neural vocoder to generate waveform samples.

Server outputs audio data representing synthesized speech of the story and stores or temporarily buffers this audio data for streaming to the terminal.

### Step 10

Server receives a purchase request and related user identification from the terminal as input when the user chooses to buy access to specific story data or distribution digital data.

Server invokes a payment processing program that creates a transaction record and communicates with an external payment service to authorize and capture the payment amount.

Server updates a purchase table in the management database to associate access rights or download identification information with the user identifier and the corresponding content identifier.

Server outputs a confirmation response containing access rights and download identification information to the terminal.

### Step 11

Server receives, as input, a content retrieval request from the terminal that specifies criteria such as language type, target age group, story genre, and distribution format.

Server performs a database query using indexed fields in the management database, filters candidate records according to the specified criteria, and selects appropriate story data, translated story data, and distribution digital data.

Server assembles a response payload that includes the selected text content, metadata, and, if permitted, links or tokens for audio data and downloadable files.

Server outputs the response payload and transmits it to the terminal via the communication network.

### Step 12

Terminal receives the response payload from the server as input.

Terminal parses the payload, extracts story text, translated story text, distribution digital data links, and audio stream endpoints, and updates its internal data model.

Terminal renders graphical interface elements, such as language selection controls, story display areas, and playback controls, based on the extracted metadata.

Terminal outputs visual presentation of the selected story and, when the user activates playback, streams the audio data from the server and outputs sound through the audio hardware.

### Step 13

User interacts with the terminal by selecting a language, scrolling through the displayed story, and optionally starting or stopping audio playback.

User may further provide feedback or additional input, such as a request for a new story or a change in preferences, which the terminal captures as new input data.

Terminal sends this new input data back to the server, which then uses it in subsequent executions of the prompt construction, generative AI model inference, translation, and distribution processes, thereby closing the interaction loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that utilize machine learning models are typically designed as one-shot text generators. Such systems generally accept a simple user input, invoke a generative model once, and then deliver static text or audio output. These systems suffer from several technical limitations in terms of computer technology.

First, existing systems do not provide an integrated, machine-controlled pipeline that automatically transforms raw user attribute information into structured prompt sentences, coordinates multiple heterogeneous processing components (generative AI model, image generation engine, speech synthesis engine, and machine translation engine), and synthesizes their outputs into a unified, machine-readable content structure. As a result, the computing resources of the various components are not used in a coordinated manner, leading to inefficiencies such as redundant calls, suboptimal content layouts, and increased end-to-end latency on the server and terminal devices.

Second, conventional systems treat the output of a generative AI model as final and do not provide a systematic mechanism to feed back real-time emotion state information from the user into the generation pipeline. In particular, existing architectures do not define a technical framework in which a processor programmatically creates additional prompt sentences based on emotion analysis results, updates the internal story representation, and selectively regenerates only affected portions of visual information data and audio data. Consequently, the use of processor, memory, and network resources is suboptimal, because even minor adjustments to the story often require full regeneration and retransmission of content, which increases processing time and network bandwidth usage.

Third, many systems that provide multilingual content merely apply generic machine translation to a completed text and do not provide any coordinated mechanism to perform culture-aware adaptation using a generative AI model in a structured way. They typically lack an intermediate representation that connects translation data, target culture information, and layout metadata. This absence of an integrated representation makes it difficult to efficiently generate and maintain multiple language versions and formats, and it often forces the system to regenerate or manually adjust large portions of content whenever a new language or cultural variant is introduced.

Accordingly, there is a need for an improved computer-implemented system that (i) programmatically converts user attribute information into structured information and prompt sentences, (ii) orchestrates interactions among a generative AI model, an image-generation processing device, a speech-synthesis processing device, and a machine-translation processing device under control of a single processor, (iii) dynamically updates story content based on emotion state information while limiting regeneration to only necessary segments, and (iv) generates culturally adapted, multilingual content in a structured content data format suitable for efficient electronic distribution. Such a system should reduce redundant computation, optimize resource allocation across different processing components, and improve responsiveness and scalability of the overall content generation platform on the server side and the terminal side.

The specific processing by the specific processing unit 290 of the data processing device 12 in Application Example 2 is realized by the following means.

The present invention provides a server comprising a processor and a memory storing instructions which, when executed by the processor, cause the processor to acquire user attribute information and generate structured information including the user attribute information; generate a first prompt sentence defining story generation conditions based on the structured information, transmit the first prompt sentence to an external generative AI model, and obtain story data including text data from the generative AI model; divide the story data into units including at least one of scene units and page units, extract summary information or descriptive information corresponding to each unit, and generate a visual-information generation prompt sentence based on the summary information or the descriptive information; generate visual information data by supplying the visual-information generation prompt sentence to an image-generation processing device; associate the story data and the visual information data with each other based on layout information and structure the associated data as content data in at least one of an electronic publishing format and a display format; input at least a part of the story data to a speech-synthesis processing device, convert the story data into audio data, and associate the audio data with playback control information; and transmit the content data and the audio data to a terminal device and perform distribution control so that the content data is displayed and the audio data is played back by the terminal device. This enables the server to orchestrate, under unified programmatic control, a multi-stage content generation pipeline that converts low-level user attribute information into a structured, multimodal, and distributable content representation, thereby reducing redundant processing, optimizing the usage of heterogeneous processing resources, and improving end-to-end responsiveness and scalability.

The present invention further provides that the server is configured to obtain imaging information and audio information from the terminal device; generate emotion state information by using an emotion analysis model to estimate a user emotion state based on the imaging information and the audio information; generate an additional prompt sentence based on the emotion state information and the story data; input the additional prompt sentence to the generative AI model to update at least one of content and progression of the story data; and regenerate at least a part of the visual information data and the audio data based on updated story data so as to dynamically modify the content data. This enables the server to adapt the story content in real time based on user emotion while limiting regeneration and retransmission to only affected segments, thus improving efficiency of processor usage, memory access, and network bandwidth utilization, and providing a technically improved adaptive content delivery mechanism.

The present invention further provides that the server is configured to input the story data to a machine-translation processing device to generate translation data in a plurality of languages; generate a cultural-adaptation prompt sentence based on the translation data and target culture information; input the cultural-adaptation prompt sentence to the generative AI model to generate culturally adapted translation data; and incorporate the culturally adapted translation data into the content data and convert the content data into a multilingual electronic distribution format for distribution. This enables the server to generate and maintain, in a unified structured representation, multiple culturally adapted language versions without regenerating the base story from scratch for each language, thereby improving the efficiency of multilingual content generation and distribution and reducing computational overhead when scaling to additional languages and cultural variants.

The term “user attribute information” refers to information indicating at least one characteristic of a user, including but not limited to age, gender, preference, interest, language preference, and usage purpose, which is used as a basis for generating story content.

The term “structured information” refers to data in which user attribute information is arranged according to a predefined schema or data structure, such as a key-value structure, list structure, or hierarchical structure, so that the data can be programmatically processed by a processor.

The term “prompt sentence” refers to a sequence of natural language tokens that defines conditions or instructions for a generative AI model, and that is used as input to cause the generative AI model to generate story data, visual information, or culturally adapted content.

The term “generative AI model” refers to a computational model implemented by one or more machine learning algorithms, configured to generate output data such as text or other content in response to an input including a prompt sentence, by performing probabilistic inference based on parameters learned from training data.

The term “story data” refers to digital data including at least text data representing a narrative, such as a sequence of sentences or paragraphs, which is generated by a generative AI model based on one or more prompt sentences.

The term “scene unit” refers to a division of story data representing an event, location, interaction, or other logical segment of the narrative, which can be processed independently for purposes including layout, visualization, or adaptation.

The term “page unit” refers to a division of story data corresponding to a display or print page, or a similar discrete visual segment, which is used to control pagination or layout in electronic or printed content.

The term “summary information” refers to data that concisely describes main elements of a scene unit or page unit, including at least a main character, setting, or key event, and which is used as a basis for generating visual information or additional prompt sentences.

The term “descriptive information” refers to data including details about characters, backgrounds, objects, or actions in a scene unit or page unit, which is suitable for conversion into a prompt sentence for image generation or other content generation.

The term “visual-information generation prompt sentence” refers to a prompt sentence used to instruct an image-generation processing device to generate visual information data that corresponds to a scene unit or page unit of the story data.

The term “image-generation processing device” refers to a computing apparatus, including hardware and software, configured to generate image data in response to an input including a visual-information generation prompt sentence, for example by executing one or more image generation models.

The term “visual information data” refers to digital data representing visual content, including at least still images or graphic elements, which is generated by an image-generation processing device based on a visual-information generation prompt sentence.

The term “layout information” refers to information defining a spatial or structural arrangement of story data and visual information data, including positions, sizes, ordering, pagination, and formatting parameters used in composing content data.

The term “content data” refers to a structured set of digital data including at least story data and optionally visual information data and metadata, arranged according to layout information and suitable for presentation or distribution in at least one format.

The term “electronic publishing format” refers to a data format used for electronic publications, including but not limited to a digital book format, a document format, or a markup-based format, which is suitable for viewing on an electronic device or for printing.

The term “display format” refers to a data representation adapted for rendering on a display device, including at least layout, styling, and media references, such that a terminal device can display the content data to a user.

The term “speech-synthesis processing device” refers to a computing apparatus configured to convert text input into audio output by executing a text-to-speech process that generates audio waveforms corresponding to spoken representations of the text.

The term “audio data” refers to digital data representing sound, including at least synthesized speech corresponding to story data, encoded in an audio format suitable for playback by a terminal device.

The term “playback control information” refers to data used to control reproduction of audio data, including timing, sequence, volume, pause, resume, and synchronization with displayed content.

The term “terminal device” refers to an end-user computing apparatus, such as a portable device, stationary device, or head-mounted device, which is configured to receive content data and audio data, display the content data, and play back the audio data to a user.

The term “distribution control” refers to processing performed by the processor to manage transmission, access, and timing of delivery of content data and audio data to one or more terminal devices, including control of start, stop, and update of content delivery.

The term “imaging information” refers to digital data representing images or video captured by an image sensor of a terminal device, including at least frames showing a user's face or body, which is used for emotion analysis.

The term “audio information” refers to digital data representing sound captured by an audio sensor of a terminal device, including at least user speech or vocal reactions, which is used for emotion analysis.

The term “emotion analysis model” refers to a computational model configured to estimate an emotion state of a user based on input data including imaging information and audio information, by performing pattern recognition or machine learning inference.

The term “emotion state information” refers to data indicating a classification or distribution of one or more emotional states of a user, such as fear, joy, boredom, calmness, or sleepiness, estimated from imaging information and audio information.

The term “machine-translation processing device” refers to a computing apparatus configured to convert text in a source language into text in one or more target languages by executing a machine translation algorithm.

The term “translation data” refers to text data obtained by applying a machine-translation processing device to source story data, the text data being expressed in at least one target language.

The term “target culture information” refers to information indicating cultural characteristics of a target audience, including at least linguistic conventions, typical expressions, and cultural references, which is used to adapt translation data.

The term “cultural-adaptation prompt sentence” refers to a prompt sentence that instructs a generative AI model to adapt translation data so that the content is culturally appropriate and natural for a target audience while preserving at least a part of the original meaning or structure.

The term “culturally adapted translation data” refers to translation data that has been modified by a generative AI model based on a cultural-adaptation prompt sentence and target culture information, such that the data conforms to cultural and linguistic norms of a target audience.

The term “multilingual electronic distribution format” refers to an electronic format of content data that includes or supports multiple language versions and that is suitable for distribution to terminal devices capable of presenting content in one or more languages.

In one embodiment, a server implements the claimed system as a network-connected computing apparatus including at least one central processing unit (CPU), at least one graphics processing unit (GPU), a volatile memory, a non-volatile storage device, and a communication interface. The server executes server-side software implemented, for example, using a general-purpose operating system, a web application framework, and application-specific modules for natural language processing, image generation, speech synthesis, and machine translation. The server communicates with one or more terminal devices over a communication network, such as a packet-switched network, using standardized protocols such as HTTP over TCP/IP.

A terminal implements a user-facing computing apparatus such as a smartphone, a tablet, or a head-mounted display. The terminal includes at least one CPU, a memory, a display device, an audio output device, a microphone, a camera, and a wireless or wired communication interface. The terminal executes client-side software, such as a native application or browser-based application, that provides a graphical user interface for inputting user attribute information, for rendering content data, and for capturing imaging information and audio information.

A user operates the terminal to input user attribute information. The user selects or inputs, through graphical user interface elements such as text fields, selection lists, and buttons, information including at least age, gender, preference, interest, preferred language, and a usage purpose (for example, bedtime story, learning content, or news-style content). The terminal converts the user input into structured information according to a predefined data schema. In one example, the schema assigns a normalized numeric representation to age, categorical identifiers to gender and language, and vectorized tags to interests and purposes.

The server receives the structured information from the terminal and stores the structured information in a data storage system such as a relational database management system. The server uses the structured information to generate one or more prompt sentences for a generative AI model. The server implements a prompt construction module that maps each field in the structured information to specific tokens or token patterns in the prompt sentence. For example, when the usage purpose is “bedtime” and the age is less than a predetermined threshold, the server appends tokens that instruct the generative AI model to generate calming, non-frightening content.

The server uses a generative AI model implemented as a neural network of the transformer architecture. The generative AI model includes an embedding layer, a plurality of self-attention layers, feed-forward layers with non-linear activation functions, layer normalization components, and an output projection layer. The generative AI model is trained on a corpus of text data using a language modeling objective that minimizes a loss function such as cross-entropy between predicted token distributions and ground-truth tokens. During training, the generative AI model updates internal parameters, including weight matrices and bias vectors, using an optimization algorithm such as stochastic gradient descent or a variant thereof. The generative AI model may also use data augmentation techniques such as token masking and permutation of training samples to improve generalization.

The server inputs the constructed prompt sentence into the generative AI model. The server converts the prompt sentence into token IDs using a tokenizer, transfers the token IDs to the generative AI model running on the GPU, and receives, as output, a sequence of token probabilities over a vocabulary. The generative AI model generates story data by iteratively selecting tokens according to a decoding strategy such as greedy decoding, beam search, or sampling with temperature control. The server converts the generated tokens back into text to obtain the story data, and stores the story data in association with the corresponding user attribute information.

In one concrete example, the server generates a prompt sentence such as:

“Create a gentle bedtime story for a 5-year-old girl who loves animals. The main setting is a magical forest. The tone should be calm and reassuring, and the story should avoid frightening scenes.”

In another example, the server generates a prompt sentence such as:

“Generate an easy-to-understand news-style article about recent environmental issues, suitable for a 15-year-old student.”

In another example, the server generates a prompt sentence such as:

“Adapt the following Japanese children's story into natural American English, keeping a warm and playful tone.”

The server structures the story data by dividing the story into units such as scene units or page units. The server implements a segmentation algorithm that analyzes sentence boundaries, discourse markers, paragraph breaks, and length constraints to identify appropriate unit boundaries. The server generates summary information and descriptive information for each unit by applying a text-processing module that identifies key entities, actions, and settings using techniques such as named entity recognition and dependency parsing. This structured segmentation reduces the need to process the entire story data when only a subset of the story is updated or adapted, improving computational efficiency.

The server generates visual-information generation prompt sentences for each segment by combining the summary information and the descriptive information in a controlled template. For example, the server may generate a prompt sentence such as:

“A pastel-colored illustration of a smiling rabbit and a small fox sitting under a big glowing moon in a magical forest, children's picture-book style.”

The server provides the visual-information generation prompt sentence to an image-generation processing device. The image-generation processing device executes an image synthesis model such as a diffusion-based neural network. The image-generation processing device converts the text prompt into a latent representation using a text encoder and then performs iterative denoising in a latent image space to generate visual information data representing a still image or other graphical content. The server retrieves the generated visual information data and associates the data with the corresponding story unit.

The server structures content data by combining the story data and the visual information data according to layout information. The layout information describes positions, sizes, and ordering of text and images relative to pages or screen regions. The server generates layout information using predetermined templates or rules that reflect the usage purpose and device characteristics. For example, for a picture-book format on a tablet, the server may allocate a large region for the image at the top of the screen and a smaller region for text at the bottom. The server generates content data in a format such as a document format, a digital book format, or a markup-based format, including references to the visual information data and metadata describing navigation sequences.

The server converts at least a part of the story data into audio data using a speech-synthesis processing device. The speech-synthesis processing device implements a text-to-speech pipeline comprising text normalization, grapheme-to-phoneme conversion, prosody prediction, and waveform generation. In one embodiment, the speech-synthesis processing device uses a neural network such as a sequence-to-sequence model with attention or a neural vocoder. The server provides the story text and voice parameters such as language, speaker type, speaking rate, and prosody style to the speech-synthesis processing device. The speech-synthesis processing device outputs audio waveforms encoded in a digital audio format. The server associates the audio data with playback control information specifying playback order, timing, and possible synchronization with text and visual information.

The terminal receives the content data and the audio data from the server. The terminal decodes the content data and renders the text and visual information on the display, and plays back the audio data through the audio output device. The terminal manages local caching of content data and audio data to reduce repeated downloads and to improve responsiveness. By structuring the content data into discrete units and by using references rather than embedding all data in a monolithic file, the system reduces memory usage and network load on the terminal.

In an embodiment that uses emotion-based adaptation, the terminal captures imaging information and audio information while the user is consuming the content. The terminal uses the camera to acquire video frames of the user's face and uses the microphone to capture the user's voice. The terminal may perform local pre-processing, such as down-sampling of images and extraction of spectral features from audio, to reduce data volume and to protect privacy. The terminal sends the processed imaging information and audio information to the server.

The server uses an emotion analysis model to estimate an emotion state of the user. The emotion analysis model may be implemented as a convolutional neural network or a recurrent neural network, or a combination thereof, trained on labeled data consisting of pairs of imaging information, audio information, and emotion labels. The training process minimizes a loss function such as categorical cross-entropy by adjusting model parameters via gradient-based optimization. The model receives as input feature vectors representing facial landmarks, facial action units, and acoustic features such as pitch, energy, and spectral coefficients, and produces as output emotion state information indicating probabilities or scores for emotion categories including fear, joy, boredom, calmness, and sleepiness.

The server combines the emotion state information with the story data to generate additional prompt sentences for the generative AI model. For example, when the emotion analysis model indicates high fear and low joy, the server may generate a prompt sentence such as:

“Given the following bedtime story and knowing that the child seems scared, rewrite the next part to be more cheerful and less intense, keeping the same characters and setting.”

The server supplies the additional prompt sentence and the relevant part of the story data to the generative AI model. The generative AI model generates updated story segments according to the additional prompt sentence. Because the story data is segmented into units, the server only updates those units that are affected by the emotion-based adjustment. The server regenerates visual information data and audio data only for the updated units, and updates the content data accordingly.

This segmented regeneration results in a technical improvement over systems that regenerate entire stories whenever an adjustment is made. The server reduces computational load on the generative AI model and the image-generation processing device, reduces the amount of audio data requiring synthesis, and reduces network traffic between the server and the terminal. As a result, the system improves processing speed, responsiveness, and scalability, particularly when many users request adaptive content simultaneously.

In a multilingual embodiment, the server uses a machine-translation processing device to generate translation data in a plurality of languages from the story data. The machine-translation processing device may be implemented as a neural machine translation model such as an encoder-decoder architecture with attention. The machine-translation processing device encodes source language sentences into latent vectors and decodes the latent vectors into target language sentences. The server receives translation data for each requested target language.

The server further performs cultural adaptation by generating cultural-adaptation prompt sentences. For example, the server may generate a prompt sentence such as:

“Adapt the following Spanish bedtime story so that it sounds natural for children in Mexico, while keeping the same plot and a gentle emotional tone.”

The server supplies the cultural-adaptation prompt sentence together with the translation data and target culture information to the generative AI model. The generative AI model modifies idiomatic expressions, names, and cultural references while preserving core story structure.

The server obtains culturally adapted translation data and incorporates the data into the content data. The server maintains a structured mapping between language codes, culture codes, story units, and layout information. This structured mapping allows the server to generate additional language versions without re-invoking the entire story generation pipeline for each new language, thereby improving computational efficiency and data management. By coordinating the generative AI model, the image-generation processing device, the machine-translation processing device, and the speech-synthesis processing device under control of the processor, the server implements a non-conventional, ordered combination of operations that improves computer technology. The server uses internal data structures that represent story units, visual prompts, audio segments, and emotion state information in an integrated manner. The server employs non-traditional processing sequences, such as generating prompt sentences dynamically based on both user attribute information and emotion state information, and performing selective update and regeneration of content. These technical features go beyond a mere automation of human editorial work and instead provide specific improvements in resource usage, latency, and scalability of a distributed content generation and delivery platform.

In an alternative embodiment, the generative AI model runs on a processing unit different from the main server, such as a dedicated acceleration node. The server manages the interaction by queueing prompt sentences and batching multiple requests together to exploit parallelism on the acceleration node. The batching mechanism reduces per-request overhead and increases throughput. In another embodiment, some simplified generative models or rule-based components execute on the terminal for local adaptations that do not require significant computation, thereby reducing round-trip latency for minor modifications. In another variation, the server uses different segmentation strategies for different content types. For example, for a comic format, the server defines segments corresponding to panels, and for a textbook format, the server defines segments corresponding to sections and exercises. The server adapts the layout templates and the prompt sentence templates to match the selected format. This variation allows the same underlying system architecture to support heterogeneous content types while reusing the same core data structures and neural models. In another embodiment, the training data and training processes of the generative AI model, the emotion analysis model, the image-generation model, and the machine-translation model are periodically updated using logs generated by the server and the terminal. The server aggregates anonymized user interaction logs, such as emotion state responses, content preferences, and performance metrics, and uses these logs to refine model parameters or to adjust prompt construction rules. The updated models and rules further improve prediction accuracy, reduce error rates in emotion estimation and translation, and enhance overall content quality and relevance, which leads to improved user experience and more efficient use of network and computing resources.

Through these embodiments and variations, the server, the terminal, and the user cooperate in a technically specific architecture that transforms low-level user attribute information and sensor measurements into structured, multimodal content data using specialized data structures, neural network models, and processing sequences. The system thereby achieves technical effects including faster adaptive content generation, reduced redundant processing, improved emotion recognition accuracy, and efficient multilingual distribution, in a manner that improves the functioning of the computer system itself rather than merely automating a human editorial process.

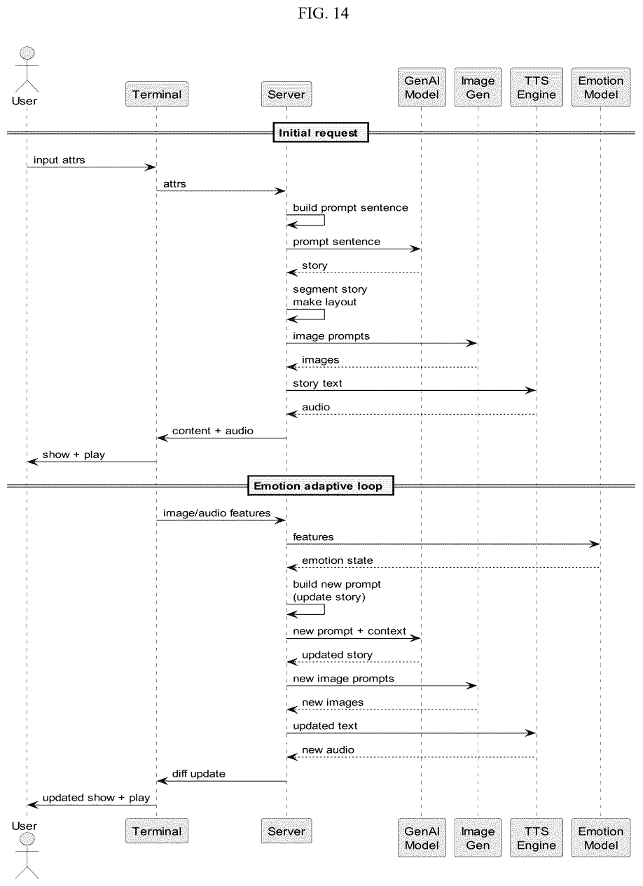

The following describes the processing flow using FIG. 14.

### Step 1

User operates the terminal to input user attribute information.

User enters age, gender, interests, preferred language, and usage purpose (for example, bedtime story, news-style content, or learning content) through a graphical user interface on the terminal.

Input: Raw user input events (touch, keyboard entries, selections).

Terminal converts these events into structured fields (for example, numeric age, categorical gender, lists of interests) and performs basic validation (range checks, required fields).

Output: Validated attribute data in a structured internal format.

### Step 2

Terminal generates structured information and sends it to the server.

Terminal maps the validated attribute fields into a predefined data schema (for example, key-value pairs and arrays) and serializes the data into a message format.

Input: Validated attribute data in internal representation.

Terminal applies encoding (for example, UTF-8) and network serialization (for example, JSON composition), then transmits the serialized structured information to the server via a network protocol.

Output: Serialized structured information delivered to the server.

### Step 3

Server receives the structured information and normalizes it.

Server parses the serialized message, reconstructs the structured information, and stores it in a data storage system.

Input: Serialized structured information from the terminal.

Server performs data normalization (for example, mapping categorical values to internal IDs, scaling numeric age values, and generating feature vectors for interests) and attaches a request identifier.

Output: Normalized structured information associated with a request ID in server memory or storage.

### Step 4

Server constructs a first prompt sentence for the generative AI model.

Server uses the normalized structured information to assemble a natural-language instruction that defines story generation conditions.

Input: Normalized structured information and prompt templates.

Server selects template fragments based on usage purpose and age, fills in variables (for example, age, interests, setting, tone), concatenates fragments, and applies text formatting to produce a coherent prompt sentence such as “Create a gentle bedtime story for a 5-year-old girl who loves animals. The main setting is a magical forest. The tone should be calm and reassuring, and the story should avoid frightening scenes.”

Output: First prompt sentence in natural-language text.

### Step 5

Server invokes the generative AI model to generate story data.

Server tokenizes the first prompt sentence and sends the resulting token sequence to the generative AI model running on a processing unit.

Input: First prompt sentence.

Server performs tokenization, forwards the token IDs to the generative AI model, receives predicted token distributions, and decodes them into text according to a decoding strategy such as beam search with a configured beam width and temperature. Server concatenates the decoded tokens into coherent text paragraphs.

Output: Story data consisting of narrative text.

### Step 6

Server segments the story data into units.

Server analyzes the story text to determine boundaries for scene units or page units according to length and semantic cues.

Input: Story data as continuous text.

Server performs sentence splitting, counts tokens or characters, detects discourse markers (for example, “later that night”, “meanwhile”), and inserts segmentation markers where constraints are met. Server creates data records for each unit containing text ranges and identifiers.

Output: Segmented story data represented as a sequence of units with associated text segments.

### Step 7

Server generates summary information and descriptive information for each unit.

Server processes each unit to extract key elements needed for visual content and later adaptation.

Input: Segmented story units.

Server applies natural language processing operations such as part-of-speech tagging, named entity recognition, and dependency parsing to identify characters, locations, objects, and actions. Server composes a concise summary sentence (summary information) and a more detailed description (descriptive information) per unit.

Output: For each unit, summary information and descriptive information linked to the unit identifier.

### Step 8

Server generates visual-information generation prompt sentences.

Server combines summary and descriptive information into image-oriented prompts.

Input: Summary information and descriptive information per unit.

Server applies an image-prompt template (for example, “A pastel-colored illustration of [main characters] in [setting], [style]”) and fills placeholders with entities and settings extracted in the previous step, ensuring style and tone match the usage purpose.

Output: Visual-information generation prompt sentences, one or more per unit.

### Step 9

Server calls an image-generation processing device to produce visual information data.

Server sends each visual-information generation prompt sentence to an image-generation model running on a GPU-equipped device.

Input: Visual-information generation prompt sentences.

Server transfers prompt text to the image-generation model, which encodes the text into latent vectors and executes an iterative denoising algorithm in a latent image space. Server receives generated image data (for example, pixel arrays or encoded image files) and associates image identifiers with the corresponding story units.

Output: Visual information data linked to story units.

### Step 10

Server composes layout information and creates content data.

Server determines how to arrange text and images on pages or screens according to device type and content type.

Input: Segmented story units, visual information data, and device or format parameters.

Server selects a layout template (for example, picture-book layout, comic layout), assigns each unit to a page or panel, calculates positions and sizes for text blocks and images, and constructs a structured representation including references to image files.

Output: Content data in a structured layout format suitable for rendering or electronic publishing.

### Step 11

Server generates audio data from the story data.

Server selects the text portions to be read aloud and forwards them to a speech-synthesis processing device.

Input: Story text for one or more units, plus voice parameters.

Server normalizes the text, sends it to the text-to-speech engine, receives synthesized audio waveforms, and encodes the waveforms into audio files. Server associates each audio segment with corresponding units and adds timing and sequencing information to playback control metadata.

Output: Audio data segments and playback control information linked to story units.

### Step 12

Server assembles a delivery package and transmits it to the terminal.

Server collects the content data, audio data, and associated metadata for the current request.

Input: Content data, audio data, and metadata (such as language, age range, total length).

Server encapsulates references and files into a delivery description (for example, a manifest with URLs and configuration parameters), applies compression or chunking if appropriate, and sends the assembled package via the communication interface to the terminal.

Output: Delivered content package available to the terminal.

### Step 13

Terminal receives the content package and prepares presentation.

Terminal parses the received manifest and retrieves required resources.

Input: Delivered content package from the server.

Terminal downloads or streams image files and audio files according to the manifest, caches them locally, and initializes UI components (for example, page view, image view, and media player) with layout and control parameters included in the content data.

Output: Ready-to-render data structures for text, images, and audio on the terminal.

### Step 14

Terminal presents the story to the user.

Terminal renders text and images on the display and plays audio through speakers or headphones.

Input: Ready-to-render data structures for text and images, audio data, and playback control information.

Terminal schedules rendering of each page or scene according to layout information, starts audio playback synchronized with the visible text where applicable, and processes user input (for example, page turns, pause, resume) to adjust display and playback states.

Output: Multimedia presentation of the story to the user.

### Step 15

Terminal captures imaging information and audio information for emotion analysis (when enabled).

Terminal activates the camera and microphone with user consent during presentation.

Input: Real-time sensor signals from the camera and microphone.

Terminal samples video frames and audio segments at predefined intervals, optionally downsamples resolutions or extracts basic features (for example, frame thumbnails, audio spectrogram patches) to reduce volume, and packages them into messages tagged with timestamps and content unit identifiers.

Output: Processed imaging information and audio information sent to the server for emotion analysis.

### Step 16

Server estimates emotion state information.

Server processes the imaging and audio information using an emotion analysis model.

Input: Imaging information and audio information with timestamps and unit references.

Server extracts feature vectors (for example, facial landmark coordinates, facial action unit intensities, pitch contours, energy levels) and feeds them to the emotion analysis model, which computes probabilities or scores for different emotion categories. Server aggregates scores over time windows aligned with story units to produce emotion state information per unit.

Output: Emotion state information associated with story units.

### Step 17

Server generates an additional prompt sentence for adaptive story modification.

Server uses the emotion state information and the existing story data to create an instruction for the generative AI model.

Input: Emotion state information and story units.

Server applies rule-based logic (for example, if fear score is above a threshold for a bedtime unit, then request less intense continuation) and constructs a new prompt sentence such as “Given the following bedtime story and knowing that the child seems scared, rewrite the next part to be more cheerful and less intense, keeping the same characters and setting.” Server appends the relevant story segment to provide context.

Output: Additional prompt sentence and contextual story input for the generative AI model.

### Step 18

Server updates story units using the generative AI model.

Server submits the additional prompt sentence and context to the generative AI model to obtain revised content.

Input: Additional prompt sentence and original story segment.

Server tokenizes the combined input, passes tokens to the generative AI model, receives generated tokens for the revised segment, and decodes them into updated text. Server replaces or appends the affected story units with the updated text and maintains mappings between old and new unit identifiers.

Output: Updated story units reflecting emotion-based adaptation.

### Step 19

Server selectively regenerates visual information and audio for updated units.

Server identifies which units have changed and recalculates associated media only for those units.

Input: Updated story units and previous associations with images and audio.

Server regenerates visual-information generation prompt sentences for changed units, sends them to the image-generation processing device to obtain new images, and resynthesizes audio segments for the changed text using the speech-synthesis processing device. Server leaves unchanged units and media untouched, and updates content data references to point to the new media.

Output: Updated visual information data, updated audio data, and revised content data for only the affected units.

### Step 20

Server transmits incremental updates to the terminal.

Server prepares a differential update package containing only changed units and associated media.

Input: Revised content data, updated images, updated audio segments, and identifiers of affected units.

Server builds an update manifest that references new resources and marks old ones as superseded, and transmits this manifest and the new resources to the terminal.

Output: Incremental update package enabling the terminal to adjust presentation without reloading the entire story.

### Step 21

Terminal applies updates and continues presentation.

Terminal integrates the updated content into the ongoing user experience.

Input: Incremental update package from the server.

Terminal replaces cached text, images, and audio for the affected units with new versions, updates internal playback schedules using the revised playback control information, and smoothly transitions to the updated content (for example, by switching audio segments at unit boundaries and refreshing visible pages).

Output: Continuously adapted story presentation that reflects real-time emotion-based modifications.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

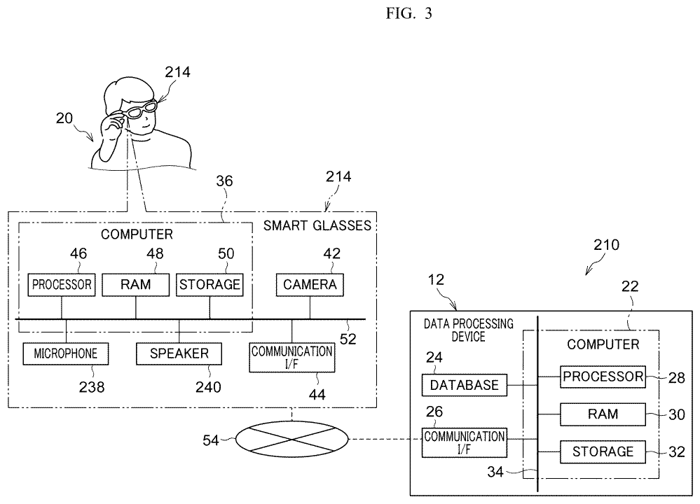

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

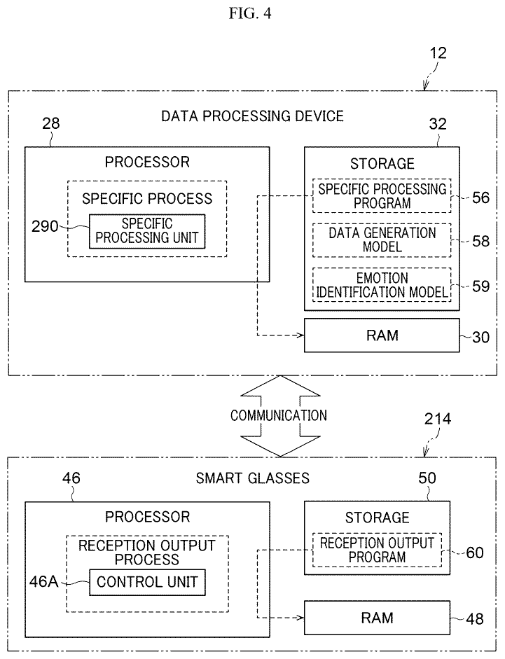

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

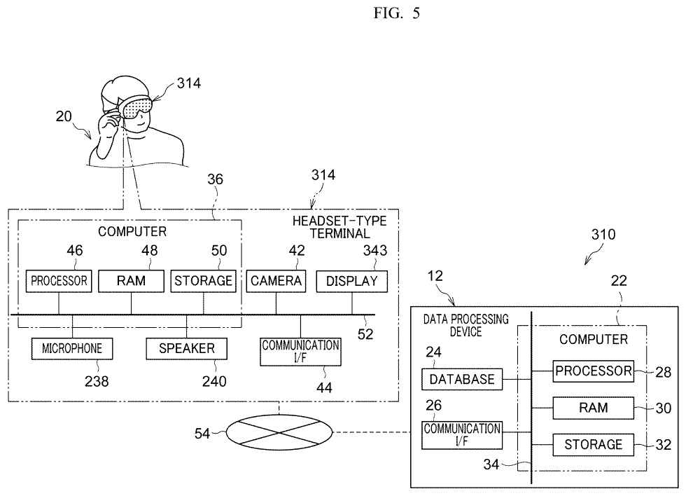

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

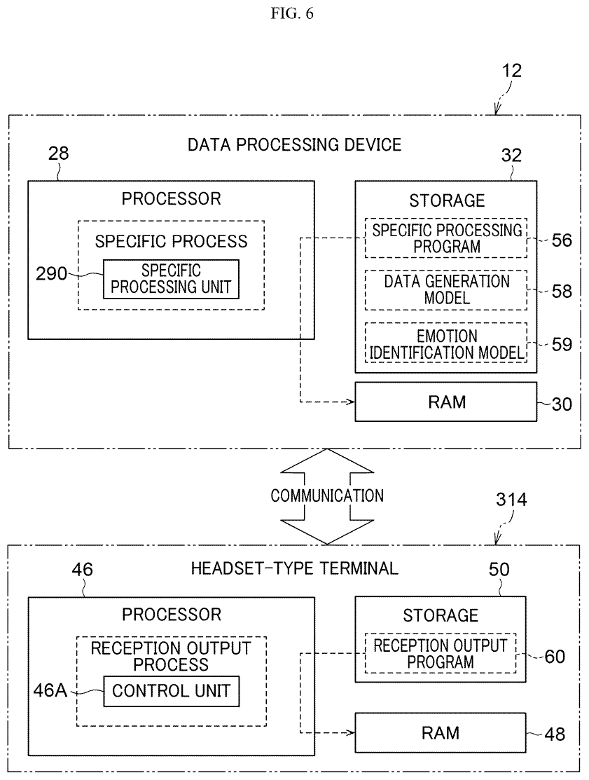

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

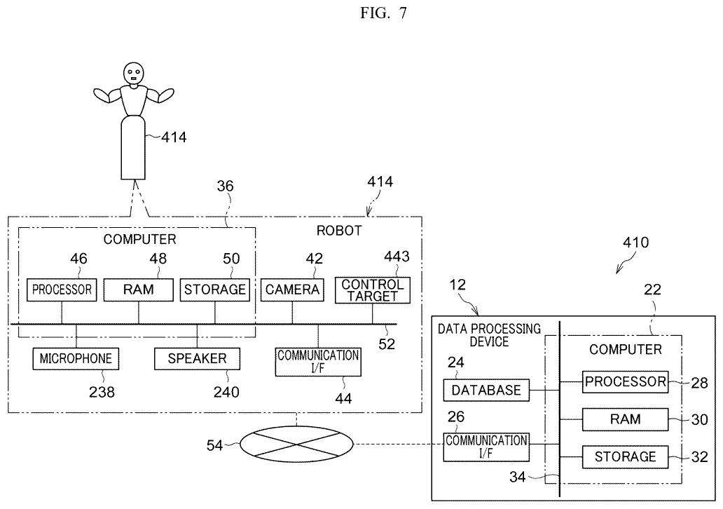

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

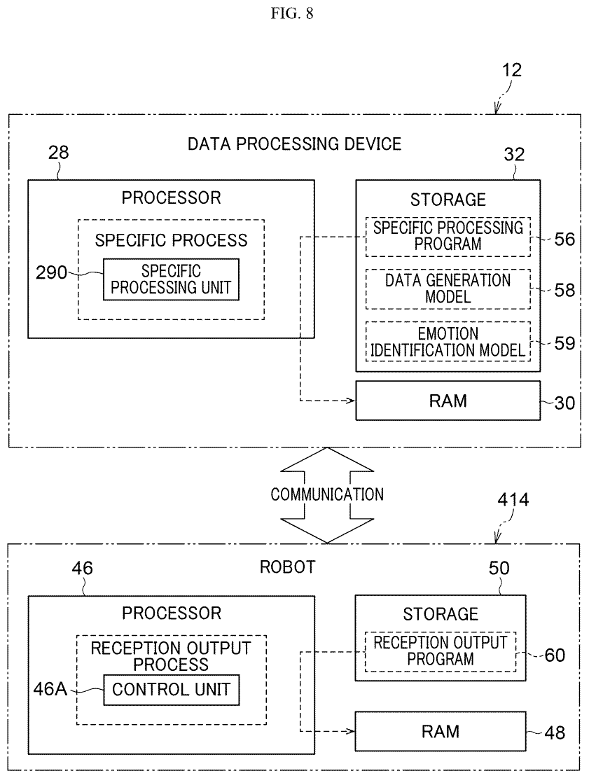

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

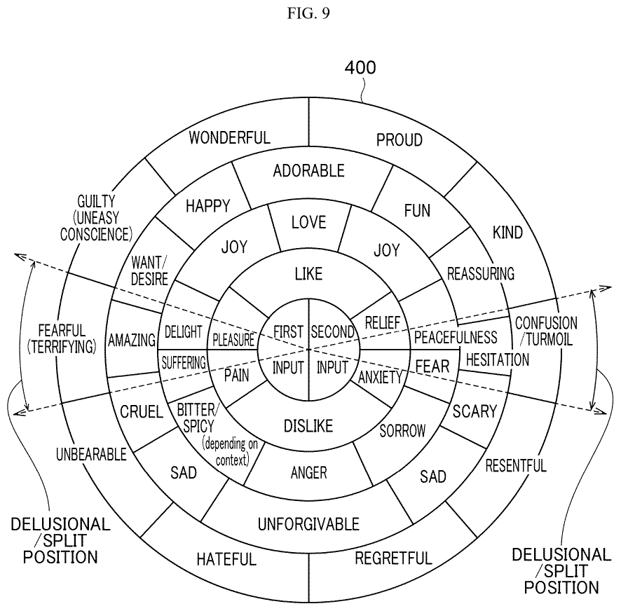

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

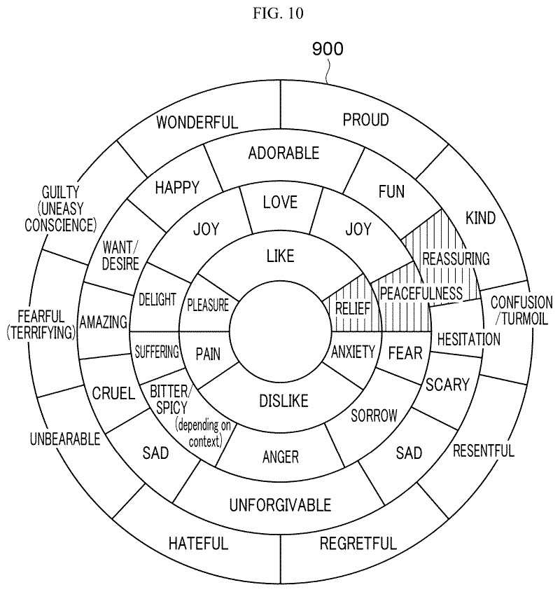

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire attribute information regarding a user, the attribute information including at least age, gender, and preference information,
generate structured information including the attribute information and dynamically construct a prompt sentence for input to a generative AI model based on the structured information,
transmit, via a communication network, request information including the prompt sentence and a generation condition to a server-side processing apparatus,
cause the server-side processing apparatus to automatically generate story text by using the generative AI model based on the prompt sentence, and to perform post-processing on the story text based on a child-suitability constraint and a length constraint,
cause the server-side processing apparatus to execute speech synthesis processing on the post-processed story text while setting control information regarding speaking rate, voice quality, intonation, and insertion of pauses so as to generate audio data,
receive, from the server-side processing apparatus via the communication network, the audio data,
store the audio data in a storage and manage the audio data in association with reproduction control information,
output the audio data from an output apparatus in response to an operation by the user, and accept operations including play, pause, stop, and volume adjustment during reproduction of the audio data, and
store, as history information, the attribute information and the prompt sentence, and automatically generate a new prompt sentence reflecting an additional input indicating a variation in content based on the history information, and cause additional story text generation to be repeatedly performed by the generative AI model.

### Supplementary 2

The system according to supplementary 1,
wherein the processor is configured to
cause the server-side processing apparatus to perform machine translation on the story text into at least one different language, execute speech synthesis processing for each of the at least one different language so as to generate a plurality of kinds of audio data, store the plurality of kinds of audio data in association with identification information as a distribution format, and provide audio data corresponding to selection designation from the processor.

### Supplementary 3

The system according to supplementary 1,
wherein the processor is configured to
cause the server-side processing apparatus to store the story text and the audio data as content information, generate catalog information for presenting the content information in an electronic distribution form, and perform distribution management processing to provide the content information for a fee or free of charge based on the catalog information.

### Application Example 1

### Supplementary 1

A system comprising a processor,
wherein the processor is configured to
acquire user attribute information,
generate a prompt sentence on the basis of the user attribute information by performing character-string processing that combines template information with the user attribute information,
supply input data including the prompt sentence to a generative information processing model and generate story information,
perform text post-processing on the story information, the text post-processing including at least one of length control, structural formatting, and removal of unnecessary information,
convert the story information into audio information by using a speech synthesis function, and
transmit the audio information to a terminal device via a communication network and cause the terminal device to output the audio information through an audio reproduction device.

### Supplementary 2

The system according to supplementary 1,
wherein the processor is configured to
include, in the user attribute information, at least one of age information, gender information, and preference information of a target person, and dynamically construct the prompt sentence so as to include conditions related to a story atmosphere and to promotion of falling asleep, in accordance with the age information, the gender information, and the preference information.

### Supplementary 3

The system according to supplementary 1,
wherein the processor is configured to
control distribution of the audio information by transmitting the audio information to the terminal device via the communication network, causing the terminal device to store the audio information, and causing the terminal device to sequentially reproduce the audio information in accordance with reproduction control information.

### Example 2

### Supplementary 1

A system comprising a processor,
wherein the processor is configured to acquire user attribute information and user input information, and to generate a prompt sentence based on the user attribute information and the user input information,
wherein the processor is configured to input the prompt sentence to a generative AI model, to cause the generative AI model to perform computation to automatically generate story data in a text format based on the prompt sentence, and to store the story data in a storage device,
wherein the processor is configured to convert the story data into translated story data in a plurality of languages by using a translation program or a translation service, and to store the translated story data in the storage device in association with respective language types,
wherein the processor is configured to convert at least one of the story data and the translated story data into distribution digital data in at least one of an electronic book format, a document format, and a web content format, and to distribute the distribution digital data to a terminal device via a communication network,
wherein the processor is configured to convert at least one of the story data and the distribution digital data into audio data by using a speech synthesis program, and to transmit the audio data to the terminal device so that a user can audibly perceive the story, and
wherein the processor is configured to execute electronic sale processing of at least one of the story data and the distribution digital data by using a payment processing program, and to provide, to a purchasing user, at least one of an access right and download identification information for the at least one of the story data and the distribution digital data.

### Supplementary 2

The system according to supplementary 1,
wherein the processor is configured to analyze an emotional state of the user based on at least one of biometric information, operation history information, and voice information of the user, and to dynamically adjust at least one of content and progression of the story by changing at least one of content of the prompt sentence, control parameters of the generative AI model, and components of the story data in accordance with the emotional state.

### Supplementary 3

The system according to supplementary 1,
wherein the processor is configured to store the story data and the translated story data in association with a management database, and, in response to a request from the terminal device, to search at least one of the story data and the distribution digital data based on at least one of language type, target age group, story genre, and distribution format, and to provide selected data to the terminal device via the communication network.

### Application Example 2

### Supplementary 1

A system comprising a processor,
wherein the processor is configured to
acquire user attribute information and generate structured information including the user attribute information,
generate a first prompt sentence defining story generation conditions based on the structured information, transmit the first prompt sentence to an external generative AI model, and obtain story data including text data from the generative AI model,
divide the story data into units including at least one of a scene unit and a page unit, extract summary information or descriptive information corresponding to each unit, and generate a visual-information generation prompt sentence based on the summary information or the descriptive information,
generate visual information data by supplying the visual-information generation prompt sentence to an image-generation processing device,
associate the story data and the visual information data with each other based on layout information and structure the associated data as content data in at least one of an electronic publishing format and a display format,
input at least a part of the story data to a speech-synthesis processing device, convert the story data into audio data, and associate the audio data with playback control information, and
transmit the content data and the audio data to a terminal device and perform distribution control so that the content data is displayed and the audio data is played back by the terminal device.

### Supplementary 2

The system according to supplementary 1,
wherein the processor is configured to
obtain imaging information and audio information from the terminal device, generate emotion state information by using an emotion analysis model to estimate a user emotion state based on the imaging information and the audio information, generate an additional prompt sentence based on the emotion state information and the story data, input the additional prompt sentence to the generative AI model to update at least one of content and progression of the story data, and regenerate at least a part of the visual information data and the audio data based on updated story data so as to dynamically modify the content data.

### Supplementary 3

The system according to supplementary 1,
wherein the processor is configured to
input the story data to a machine-translation processing device to generate translation data in a plurality of languages, generate a cultural-adaptation prompt sentence based on the translation data and target culture information, input the cultural-adaptation prompt sentence to the generative AI model to generate culturally adapted translation data, and incorporate the culturally adapted translation data into the content data and convert the content data into a multilingual electronic distribution format for distribution.

What is claimed is:

1. A system comprising:
circuitry configured to:
receive, via a communication interface coupled to a packet-switched network, request data from a terminal device, the request data including a prompt sentence dynamically constructed based on attribute information of a listener, the attribute information comprising at least an age parameter, a gender parameter, and a preference parameter, and store the attribute information in a storage device;
prepare model input data comprising the prompt sentence and generation control parameters, invoke a generative model using the model input data, and receive story text generated by the generative model;
perform post-processing on the story text according to at least one constraint comprising a child-appropriateness constraint and a length constraint, the post-processing comprising at least content filtering, length normalization, and insertion of markup for speech synthesis;
execute speech synthesis processing on the post-processed story text by applying speech control information comprising at least a speaking rate parameter, a voice characteristic parameter, an intonation parameter, and a pause insertion parameter, so as to generate audio data; and
store the story text and the audio data in association with catalog information and identification information in the storage device, and transmit the audio data to the terminal device via the communication interface in response to a distribution request from the terminal device.

2. The system according to claim 1, wherein the circuitry is configured to perform machine translation on the post-processed story text into at least one additional language, execute the speech synthesis processing for each additional language so as to generate a plurality of audio data variants, and store the plurality of audio data variants in association with respective language identification codes and the identification information.

3. The system according to claim 2, wherein the circuitry is configured to receive, in the distribution request from the terminal device, a language selection parameter, and to select from the plurality of audio data variants the audio data variant corresponding to the language selection parameter for transmission to the terminal device.

4. The system according to claim 1, wherein the circuitry is configured to receive, together with the request data, emotion state data representing an estimated emotion state of the listener, and to adjust the generation control parameters based on the emotion state data such that a narrative tone or a story pacing of the generated story text is adapted to the estimated emotion state.

5. The system according to claim 4, wherein adjusting the generation control parameters based on the emotion state data comprises mapping the emotion state data to a tone descriptor and a pacing value, and embedding the tone descriptor and the pacing value into the model input data as generation instructions.

6. The system according to claim 1, wherein the circuitry is configured to store, in the storage device, history information comprising the attribute information and a sequence of previously transmitted prompt sentences in association with the identification information, and to generate a new prompt sentence for a subsequent story by constructing the new prompt sentence based on the history information and an additional variation instruction received from the terminal device.

7. The system according to claim 6, wherein generating the new prompt sentence comprises extracting a thematic element from a most recently transmitted prompt sentence in the sequence and incorporating the thematic element together with the additional variation instruction into the new prompt sentence.

8. The system according to claim 1, wherein the child-appropriateness constraint is enforced by a content filtering step that evaluates the story text against a vocabulary exclusion list and a topic exclusion list, and removes or replaces any text portion matching an entry in the vocabulary exclusion list or the topic exclusion list.

9. The system according to claim 8, wherein the circuitry is configured to transmit, when a removed text portion exceeds a length threshold, a regeneration prompt sentence to the generative model requesting replacement content conforming to the child-appropriateness constraint, and to replace the removed text portion with content received from the generative model in response to the regeneration prompt sentence.

10. The system according to claim 1, wherein the speech control information is determined by the circuitry based on the age parameter of the listener, such that a first speaking rate and a first intonation range are applied when the age parameter indicates a first age range, and a second speaking rate and a second intonation range are applied when the age parameter indicates a second age range different from the first age range.

11. The system according to claim 10, wherein the first speaking rate is lower than the second speaking rate and the first intonation range is wider than the second intonation range, corresponding respectively to a younger listener age range and an older listener age range.

12. The system according to claim 1, wherein the generation control parameters include a narrative structure parameter specifying at least one of a story arc type, a number of chapters, and an ending type, and wherein the narrative structure parameter is determined based on the preference parameter of the listener.

13. The system according to claim 12, wherein the narrative structure parameter is retrieved from a preference-to-structure mapping table stored in the storage device, and wherein the preference-to-structure mapping table is updated based on feedback signals received from the terminal device indicating a listener's satisfaction with a previously generated story.

14. The system according to claim 1, wherein the circuitry is configured to receive playback control signals from the terminal device comprising at least one of a play instruction, a pause instruction, a stop instruction, and a volume adjustment instruction, and to control transmission of the audio data to the terminal device in accordance with the received playback control signals.

15. The system according to claim 14, wherein the circuitry is configured to store a playback position associated with a pause instruction in the storage device in association with the identification information, and to resume transmission of the audio data from the stored playback position in response to a subsequent play instruction from the terminal device.

16. The system according to claim 1, wherein the catalog information comprises at least a story title, a story duration, a language code, a narrative theme code, and a target age range, and wherein the circuitry is configured to return a catalog record matching search criteria received from the terminal device.

17. The system according to claim 16, wherein the circuitry is configured to generate a recommended catalog entry by selecting a story from the storage device whose narrative theme code and target age range match the attribute information received from the terminal device, and to transmit the recommended catalog entry to the terminal device prior to receiving the distribution request.

18. A system comprising:
circuitry configured to:
receive, via a communication interface coupled to a packet-switched network, a prompt sentence constructed based on attribute information of a listener from a terminal device, the attribute information comprising at least an age parameter, a gender parameter, and a preference parameter;
prepare model input data comprising the prompt sentence and generation control parameters, invoke a generative model using the model input data, and receive story text generated by the generative model;
perform post-processing on the story text comprising content filtering and length normalization; and
execute speech synthesis processing on the post-processed story text using speech control information comprising at least a speaking rate parameter and a voice characteristic parameter to generate audio data, and transmit the audio data to the terminal device via the communication interface.

19. The system according to claim 18, wherein the circuitry is configured to store the story text and the audio data in association with catalog information and identification information in a storage device, and to transmit selected audio data to a plurality of terminal devices in response to respective distribution requests based on the catalog information.

20. A method comprising:
receiving, via a communication interface coupled to a packet-switched network, request data from a terminal device, the request data including a prompt sentence dynamically constructed based on attribute information of a listener, the attribute information comprising at least an age parameter, a gender parameter, and a preference parameter, and storing the attribute information in a storage device;
preparing model input data comprising the prompt sentence and generation control parameters, invoking a generative model using the model input data, and receiving story text generated by the generative model;
performing post-processing on the story text according to at least one constraint comprising a child-appropriateness constraint and a length constraint, the post-processing comprising at least content filtering, length normalization, and insertion of markup for speech synthesis;
executing speech synthesis processing on the post-processed story text by applying speech control information comprising at least a speaking rate parameter, a voice characteristic parameter, an intonation parameter, and a pause insertion parameter, so as to generate audio data; and
storing the story text and the audio data in association with catalog information and identification information in the storage device, and transmitting the audio data to the terminal device via the communication interface in response to a distribution request from the terminal device.
